(19) United States
(12) Patent Application Publication
(10) Pub. No.: US 2024/0422865 A1
(43) Pub. Date: Dec. 19, 2024

(54) ONE PIECE HEATER RACK, HEATER ASSEMBLY USING THE HEATER RACK, AND METHOD OF USE

(71) Applicant: TUTCO, LLC, Cookeville, TN (US)

(72) Inventors: James Patrick LOLLAR, Cookeville, TN (US); Devin RIDLEY, Cookeville, TN (US)

(21) Appl. No.: 18/820,485

(22) Filed: Aug. 30, 2024

Related U.S. Application Data
(63) Continuation-in-part of application No. 16/879,899, filed on May 21, 2020, now Pat. No. 12,089,299.
(60) Provisional application No. 62/857,348, filed on Jun. 5, 2019.

(51) Int. Cl. H05B 3/06; H05B 3/54

(52) U.S. Cl. CPC H05B 3/06; H05B 3/54; H05B 2203/005

(57) ABSTRACT

A one-piece heater rack includes a number of arrays of attachment nodes and a surrounding peripheral structure. The attachment nodes are configured to allow the attachment of ceramic supports, the ceramic supports designed to hold open type coil electrical resistance heating elements that make up of a heater assembly using the heater rack. The attachment nodes allow attachment of the ceramic supports from above and below the heater rack for ease of installation. The heater rack also includes other features that providing mounting support for other heater assembly elements like terminals, thermostats, temperature limit switches, and air flow control over and through the heater using the peripheral structure, the arrays of attachment nodes or combinations thereof.

### FIELD OF THE INVENTION

The invention relates to a one piece heater rack designed to support one or more open type coil electrical resistance heating elements using ceramic supports, allow for flow of air parallel to the rack or flow of air through the rack, include structure as part of the one piece heater rack to accommodate mounting different heater components such as thermostats or linear temperature limit devices, and provide a rack configuration that minimizes the risk of the open type coil electrical resistance heating elements contacting parts of the rack and short circuiting.

### BACKGROUND OF THE INVENTION

In the prior art, open type coil electrical resistance heater assemblies are commonly used in various heating applications. These types of heater assemblies use one or more open coil resistance elements that are mounted to a heater rack using ceramic supports.

One common problem with these type of open coil electric heater assemblies is the fact that many parts have to be compiled and assembled to complete a finished heater assembly. That is, one begins with a large list of items that must be fabricated separately, put together in some order and fashion, and then attached, welded or combined with all other parts for a finished heater assembly.

Additionally, often times during these operations, material is removed from a raw material stock, never to be utilized further and this wasted material contributes to the cost of the heater assembly.

An example of a heater assembly that utilizes a number of parts to make the assembly is disclosed in U.S. Pat. No. 6,624,398 to Sherrill et al. The insulator support structure in this heater may be unique but the heater includes many weld points and added parts for the final assembly to be mounted. The end result in this case is a heater assembly that requires many individual parts to be fabricated separately and extensively fastened together in order to include all required features and to provide a final assembly. The more parts are involved, the more complicated the assembly becomes and, the more features that are added, the more individual parts are needed.

U.S. Pat. No. 6,593,554 to Danko et al. is another example of a defined heater assembly that uses a unique insulator support structure but includes many weld points and added parts for the final assembly to be mounted. For example, this heater assembly, in addition to providing a frame for the heater, uses a separate metal plate to provide supports for the terminal ceramic supports and thermostat, see FIG. 2 thereof.

U.S. Pat. No. 6,020,577 to Barker discloses another heater assembly that starts with a larger sheet that has much material removed, then repurposed and folded into a related structure used for the element support structure. This heater assembly also allows for multiple coils to be attached. However, many additional components are required to complete the entire heater assembly, e.g., more parts required and more assembly needed to supply a means for attaching the terminal ceramic supports, thermostats, mounting brackets, etc., see FIG. 2 thereof. Another problem with this kind of heater is that it is only suitable for air flow that is parallel to the coil support rack. It cannot be used in a situation where air would flow through the coil support rack as there is insufficient space or passageways for the air to flow.

U.S. Pat. No. 6,087,639 to Engelke et al. shows a retainer bracket or a single support rack for a heater assembly. This rack allows the open coil heating element to pass through openings in the rack in a string through style. This heater assembly is also specifically designed to heat air flowing parallel to the rack surface or an air flow over configuration, not perpendicular to the rack surface. There is no disclosure of the retainer bracket having additional features or structure allowing mounting of other heater components.

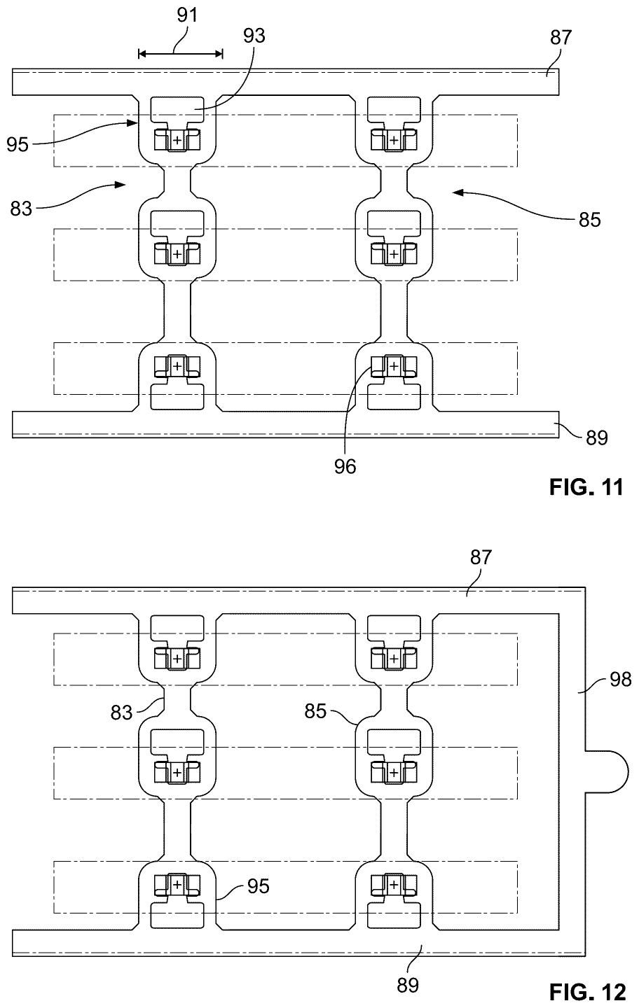

Pre-Grant Publication No. 2008/0173636 to Kutz is another example of the use of a large sheet to form a heater support rack. While forming this rack results in a lot of waste of material due to the rack central opening, this waste is mandated by the functionality of the rack itself. Also, adding additional coil elements to the rack is problematic and other parts requiring fabrication and assembly would be required and this is shown in FIGS. 10 and 11 of Kutz. It should be noted that in Kutz, the intended air flow is perpendicular to the surface or face of the rack and the rack configuration is not designed to allow air flow over the face of the rack or parallel thereto.

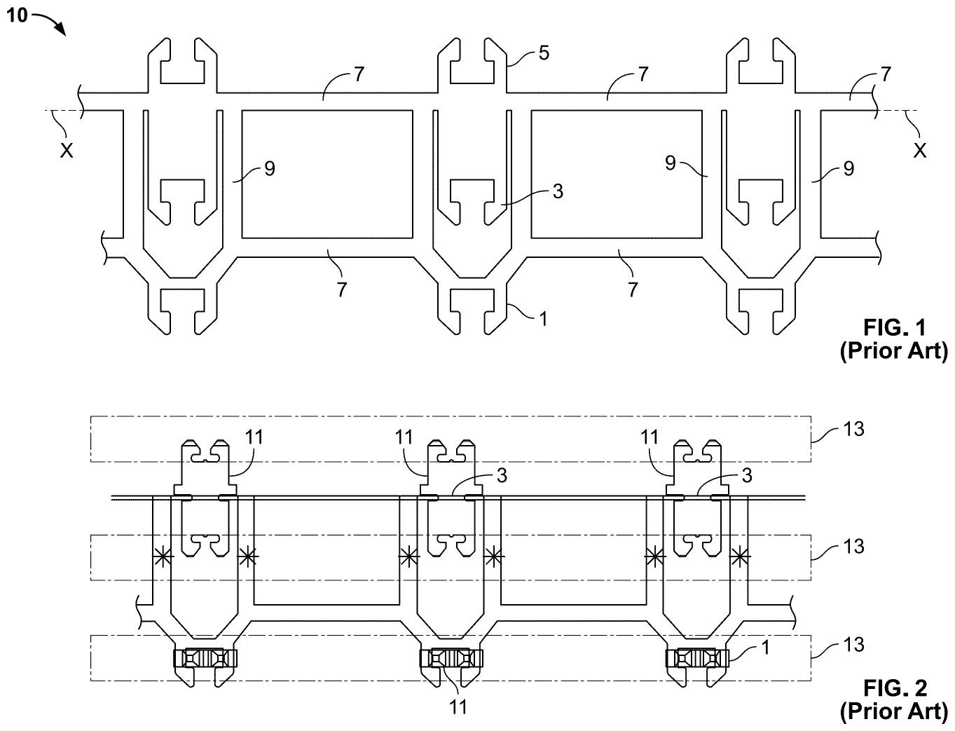

U.S. Pat. No. 4,528,441 to Seal et al. is another example of a heater rack that supports open coil resistance elements. Seal et al. teaches the use of a mounting bar 6 that employs a cross bar 5, wherein the cross bar 5 connects to a ceramic support that holds the open coil resistance element, see FIG. 1. However, a basic failing here is that it does not leave room for the contemplation of providing a much wider part, so as to include more and more coils over a broader airflow width, which is typical for larger heat kits often found in residential AHU's and the like. This type of assembly is common and is often referred to in the field as a shish kebab heater rack and often is supplied with a max. Kw of around 5.0 to 6.0. This means that multiple versions of this assembly are needed used for a final and complete assembly, which can supply a most typical maximum total Kw of around 20.0. This also means that, typically, the assembly may need around 20/5=4 total coil sets or shish kebab rack assemblies for final completion. While Seal et al. does not illustrate a larger assembly, it would require more and more parts for the final product. Another problem with Seal et al. is that if the design were simply made wider, the ceramic coil support twist mechanism labeled 7 could not continue on with the width of the parts and allow another ceramic support to be attached due to interference. Also, attempting to link the mounting bars together with connecting structure can result in clearance and short circuit problems as coils could sag where they cross the connecting structure.

Another example of a shish-kebab heater is shown in U.S. Pat. No. 6,376,814 to Holmes. Holmes uses a pinch tine technique to support the ceramic insulators on the cross bars but suffers from the same drawbacks as Seal et al. in terms of finding ways to support more coils without having to add additional structure. The heater of Seal et al. is constrained to basically 4 rows of coils, two upper and two lower. Also, with the pinch tine technique, there has to be tool access to the tines when securing the ceramic supports. Having this tool access limits where the tines can be placed on a given rack and constrains the ability to increase the number of coils held by a particular rack.

U.S. Pat. Nos. 6,433,318 and 6,660,141 to Danko et al. are also examples of prior art heater racks that require a number of additional structural features and components to complete a heater assembly.

FIGS. 1 and 2 show a portion of another prior art heater rack that is designated by the reference numeral 10. The rack portion 10 has a plurality of three sets of ceramic support areas, called attachment nodes 1, 3, and 5, the attachment nodes using the tine pinch method of ceramic support attachment disclosed in Holmes. The rack portion 10 is designed to be bent so that the attachment nodes 3 and 5 are in a plane that is perpendicular to the plane of the attachment node 1. The rack portion also includes connecting arms 7 and cross arms 9. The connecting arms 7 interconnect the attachment nodes 1, 3, and 5 with the cross arms 9 connecting the cross arms 7 together. Although not shown, the rack portion 10 would ultimately terminate with end portions that link to the connecting arms 7.

FIG. 2 depicts a heater rack portion assembly including the rack portion 10 of FIG. 1, ceramic supports 11 and open coil resistance elements or coils 13. The rack portion 10 of FIG. 1 is bent along the line X-X of FIG. 1. In the bent condition, the attachment nodes 3 and 5 lie in a plane perpendicular to a plane that contains the attachment node 1. Each attachment node 1, 3, and 5 includes a ceramic support 11. As is known in the art, ceramic supports are configured to both attach to a heater rack and a coil so as to support the coil and maintain a separation between the coil and heater rack to avoid short circuiting of the heater assembly.

An example of an arrangement of a ceramic support 11′ and a coil 13 is shown in FIG. 3. The ceramic support 11′ has end portions 15 that are configured to engage the coil portion 17 of the coil 13. The ceramic support 11′ also includes a narrowed center portion or a slot 19, which is configured to attach to a part of a heater rack. It should be understood that ceramic supports can have any number of configurations to attach to a heater rack. As noted above, the Holmes patent shows a pinch tine type attachment, wherein the heater rack attachment nodes are designed to expand to receive a center portion of the ceramic point in a slot in the attachment node and then pinch back to hold the ceramic support in place.

Referring back to FIG. 2, in the bent configuration, the heater rack portion 10 can hold six coils 13, with three of the coils shown in FIG. 2 by dashed lines. Two coils use attachment nodes 1 and its ceramic supports 11 and four coils use attachment nodes 3 and 5 and their respective ceramic supports 11. A problem with this design is illustrated by the “*” or star marks in FIG. 2. The star marks represent surfaces on the rack portion 10 that can come into contact with one of the coils 13 if that coil should sag and cause a short circuit.

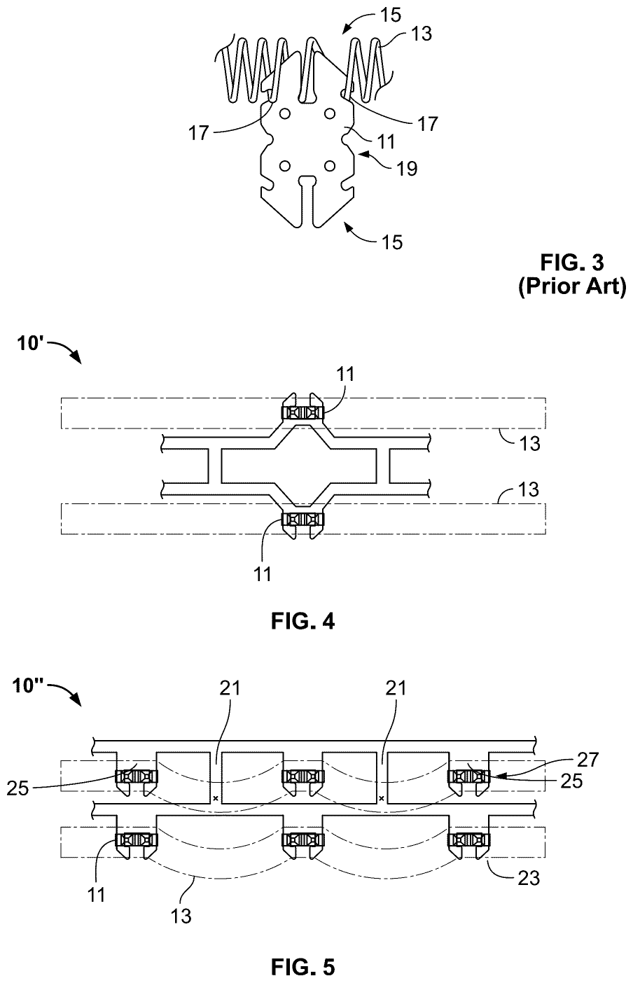

The short circuiting problem above could be avoided by using a rack portion 10′ with just two attachment nodes as shown in FIG. 4, but this suffers from the limitation of only using two ceramic supports 11, which only support four coils. Rack portion 10″ in FIG. 5 suffers from the same sag and short circuiting issues shown in FIG. 2 at the “x” at locations 21. The attachment nodes 23 in FIG. 5 also present a problem in terms of access to the attachment nodes when using the pinch tine method of Holmes on the rack to attach to the ceramic support. This method of attachment requires tooled access to the tines on the rack end zones 25 in the FIG. 5 arrangement are not easily accessed by tools to attach the ceramic support 11 to the attachment node 23.

Another problem with prior art heaters is that they are not configured to be used regardless of whether air is flowing parallel to the plane of the heater rack holding the coils, which is called air flow over, or air is flowing perpendicular to the plane of the heater rack, which is called air flow through.

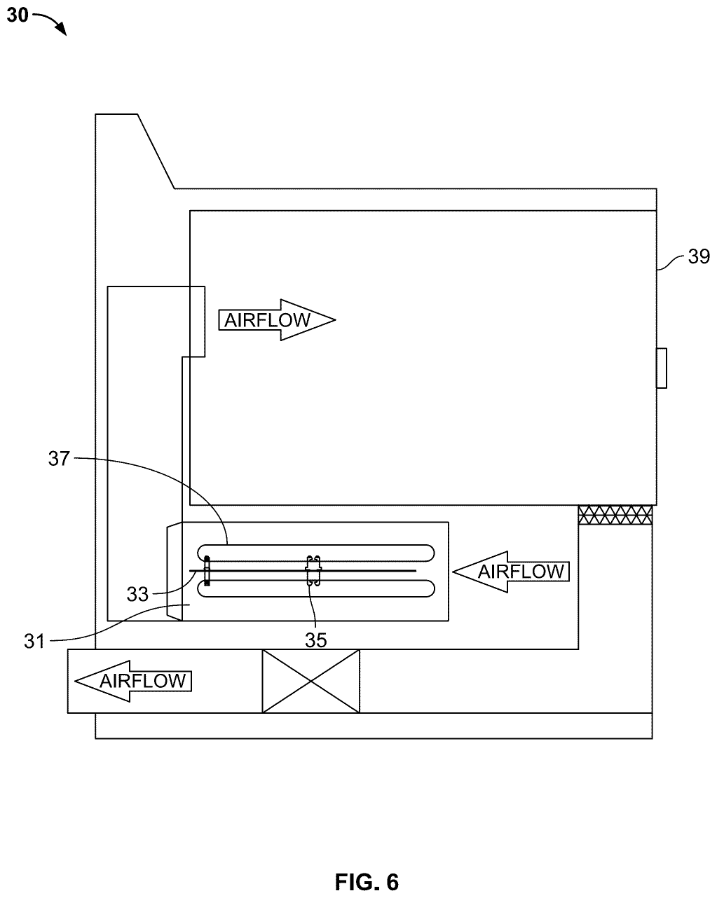

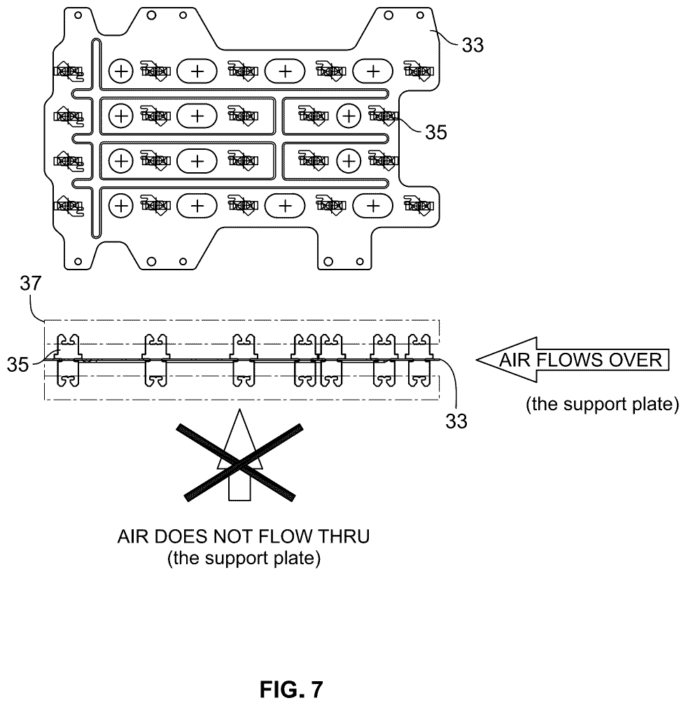

With reference now to FIGS. 6 and 7, FIG. 6 shows a schematic of a clothes dryer designated by the reference numeral 30. The clothes dryer includes a heater 31. The heater 31 includes a heater rack 33, a number of ceramic supports 35 and coils 37. The air flow through the clothes dryer 30 is also depicted with various arrows in FIG. 6. It can be seen that the air flows over the heater rack 30 for heating purposes and then flows to the clothes drum 39 for clothes drying.

The heater rack 33 is shown in more detail in FIG. 7. It can be seen from this drawing that the heater rack 33 has few through openings and air flow through the rack would be insufficient for heating purposes and a risk of overheating of the heater would exist. Thus, the heater rack 33 could not be used in an application that required flow through the rack for heating purposes or in the flow through direction that is x'd out in FIG. 7.

With the requirement that prior art rack designs use multiple components to form a heater assembly, the inability for prior art heater racks to support larger numbers of coils without risking short circuiting by having structure close to the coils, the excessive waste encounters from sheet material when forming the racks, having special tooling access to assemble the heater, and the inability for heater racks to accommodate both air flow over and air flow through applications, a need exists for an improved heat rack design that allows, for example, for the use of multiple coils without the need for extra parts while minimizing the risk of short circuiting, less waste, and easier assembly. The present invention responds to this need by providing a unique open coil resistance element heater rack.

### SUMMARY OF THE INVENTION

One object of the invention is a one-piece heater rack that is designed to support open type coil electrical resistance heater elements using ceramic supports.

Another object of the invention is to provide the one-piece heater rack in a configuration that allows the heater rack not only to retain the ceramic supports but do so in a way that makes it easy to connect the ceramic supports to the heater rack.

Yet another object of the invention is to provide a heater rack that can be configured to accept other heater components and allow the heater rack to be configured for purposes of increasing its strength, allowing the heater rack to be used in situations where air flow would be either over the rack or through the rack, include features in the heater rack to enhance air flow control, and all without the need for the use of additional components, welding steps, fastening steps, and the like.

Other objects and advantages will become apparent as a description of the invention proceeds.

In satisfaction of the foregoing objects and advantages of the invention, the invention is an improvement in heater racks that are used in heater assemblies and comprises a single sheet of material having a front side and a back side. The single sheet of material further comprises a peripheral structure, and a plurality of arrays of attachment nodes. Each attachment node is configured to secure at least one ceramic support to the attachment node, the attachment nodes extending between portions of the peripheral structure. In order to attach the ceramic supports to the heater rack, each attachment node has a peripheral portion that forms a first opening configured to allow a ceramic support to be positioned in the opening from either the front side or the back side. The peripheral portion also forms a second opening that is configured to receive a central portion of the ceramic support by either sliding or twisting of the ceramic support. The attachment node also includes a tab extending into the opening to retain the ceramic support in the opening by tab bending.

While the heater rack could function with just the array of attachment nodes, it can also include at least one plate member. The at least one plate member can be part of the peripheral structure, be positioned between adjacent attachment nodes of a given array, or be positioned between adjacent attachment node arrays. In another embodiment, two or more plate members can be provided and used as both part of the peripheral structure and between adjacent attachment node arrays. The at least one plate member can have one or more openings therein to provide different functionality for the heater rack. These functionalities include facilitating the mounting of various heater components like thermostats, temperature limit switches, temperature cut off device, terminals and other known heating assembly components. Other functionalities include configuring the plate member to assist in control of air flow over or through the one-piece heater rack and providing a bending or folding capability to the plate member for component mounting purposes and the like. Other parts of the peripheral structure can be bent as well for strength enhancement, creating channels for wiring for radiant heat protection and the like.

The attachment nodes can be positioned in the arrays in any number of ways, including both an even spacing between attachment nodes in a given array or uneven spacing in the array. This ability to provide different spacings between the attachment nodes allows the heater rack to create different configurations for the coil being supported thereby. The attachment nodes can also vary in size to handle different sized and types of ceramic supports and coils.

The arrays of attachment nodes include a connecting arms positioned between adjacent attachments nodes in a given array. The width of the connecting arm relative to the width of the attachment node can vary such that the connecting arm could have a width smaller, larger, or the same as the attachment node. Having a larger width for the connecting arm improves the overall strength of the heater rack.

Another feature of the inventive heater rack, while using a large number of ceramic supports and extensive coil rungs, is minimizing the chances of a short circuit due to the coil sagging and contacting a part of the heater rack. That, the adjacent second openings in the attachment nodes that would function to support a coil in a direction that aligns with the second openings are separated by an open space. The adjacent second openings could be part of an array of attachment nodes or second openings in adjacent arrays of attachment nodes. In either case, the adjacent second openings are separated by an open space that does not contain any structure of the one-piece heater rack. With this open space, if a coil segment between two ceramic supports and adjacent attachment nodes were to sag, there would be no structure for the sagging coil segment to contact and cause a short circuit in the heater assembly.

Another aspect of the invention is the ability of the attachment nodes to hold more than one ceramic support. The attachment node could be configured with at least two second openings to support a pair of ceramic supports. The two openings could be combined with the first opening so that the same opening could be used to insert the ceramic supports into the respective second openings. Alternatively, the attachment node could have two first openings and two second opening to accommodate a pair of ceramic supports. It is conceivable that additional openings could be formed in the attachment nodes to hold even more ceramic supports.

For the sliding attachment of the ceramic supports to the attachment nodes, the second opening is in the form of a slot adjacent to the first opening. The slot is adapted to slidably receive a central portion of the ceramic support for securement to the attachment node. For the twisting attachment of the ceramic support, the second opening is in the form of a pair of cut-outs in opposing edges of the first opening, the pair of cut-outs receiving a central portion of the ceramic support upon twisting of the ceramic support.

The arrays of attachment nodes can have any number of orientations for the heater rack. The arrays could be aligned in a parallel fashion. Alternatively, additional connecting arms could be provided so that the arrays not only run in one direction, but arrays of attachment nodes are formed that run perpendicular to those aligned in parallel.

The flexibility of the heater rack and creating the attachment nodes from a single sheet of material also allows the placement of the attachment nodes in one of more of the arrays to be oriented or angled with respect to the array direction so that a coil so mounted to ceramic supports held in the angled attachment nodes would follow a non-linear path.

Regarding the peripheral structure of the heater rack, in some embodiments, the peripheral structure would be connected together peripheral members that would surround the array of attachment nodes. In other embodiments, one or more plate members could function as part of the peripheral structure. In yet another embodiment, an array of attachment nodes and connecting arms could act as one of the peripheral members of the heater rack.

The plurality of arrays of attachment nodes could be provided in sets that are separated by a plate section. The plate section could be bendable along two spaced apart lines extending along the plate section. The plate section could be bent along the two spaced apart lines so that the two sets of plurality of arrays of attachment nodes would be parallel to each other after bending. In effect, the heater rack would become u-shaped with one end of the u-shape having one heater assembly of coils and ceramic supports and the other end of the u-shape having a second heater assembly of similar construction.

The invention also encompasses a heater assembly that uses the inventive heater rack in combination a plurality of ceramic supports connected to the attachment nodes and one or more coils connected to the ceramic supports.

The heater assembly using the inventive heater rack can be used in virtually any application that requires heating of a desired space. This heater assembly could be used to heat air flowing in a duct for a living space, a clothes dryer, space heaters, and the like. The method of use would simply involve placing the heater assembly in the desired location and supplying power to the heater assembly to generate the desired heating using the coils.

Another embodiment of the invention uses the same kind of attachment nodes described above, either the attachment node wherein the ceramic support slides into an opening to be in the operational position or is twisted to be in the operational position and wherein the peripheral portion of the attachment node completely surrounds the openings of the attachment node that are intended to receive and engage the ceramic support. The difference in this new embodiment is that the attachment node does not need the tab or other mechanical feature to retain the ceramic support in the operational position. More specifically, the ceramic support can be held in place by engagement with the helical heating coil. This engagement prevents the ceramic support from back to its insertion position, e.g., sliding back to the first opening or twisting back to the first opening, and possibly being disengaged from the attachment node itself.

This tab-less attachment node can be used in any of the embodiments described above for the tab-containing attachment node.

The tab-less attachment node wherein the peripheral portion of the attachment node completely surrounds the attachment node openings can also have a configuration wherein the ceramic support can freely rotate with respect to attachment node as opposed to a configuration wherein the rotation of the ceramic support is limited by the shape of the second openings. For this 360 degree rotation embodiment, the second opening in the attachment node can include at least one curved edge face for engaging a central portion of the ceramic support, preferably just one curved edge face that terminates with the first opening. In an alternative configuration, the second opening can include a pair of opposing curved edge faces for engaging a central portion of the ceramic support, the first opening being slot portions on either side of the opposing curved edge faces.

Another embodiment of the invention relates to an attachment node that, in contrast to the attachment node that includes a peripheral portion that completely surrounds the attachment node openings, includes a slot in the peripheral portion. The presence of the slot allows the ceramic support to be inserted into the attachment node opening through a side face of the attachment node or from either planar surface of the attachment node.

The slot and opening(s) in the attachment node can be configured in one mode to allow for 360 degree rotation of the ceramic support once it is placed in its insertion position in the attachment node. In a second mode, the attachment node opening can include faces to limit rotation of the ceramic support, e.g., counterclockwise rotation, when in its operational position to a certain degree, but not prevent rotation in the opposite direction, e.g., clockwise rotation. In either mode, the ceramic support can still be moved back to its insertion position as there is no mechanical feature or means to prevent such movement.

Another embodiment of the invention, whether the attachment node includes a slot or not, is a heater rack, wherein the peripheral structure that holds the attachment node arrays is movable with respect to the heater rack. This movability offers even more flexibility in terms of heater performance to a heater rack that already includes a plate member that is movable with respect to the heater rack.

For a heater rack that includes an attachment node whose peripheral structure completely surrounds the attachment node openings, the attachment node can be configured with slot portions as first openings that permits ceramic support insertion in the attachment node and spaced apart second openings that allow for 360 degree twisting movement of the ceramic support into its operational position.

For the embodiment wherein the attachment node includes a slot, the one-piece heater rack for supporting open coil electrical resistance heater elements using ceramic supports comprises a single sheet of material having a front side and a back side. The single sheet of material has a peripheral structure and a plurality of arrays of attachment nodes. Each attachment node is configured to secure at least one ceramic support to the attachment node, the attachment nodes extending between portions of the peripheral structure.

Each attachment node includes a peripheral portion that forms a first opening configured to allow a ceramic support to be positioned in at least a portion of the first opening (an insertion position) and a second opening configured to receive a central portion of the ceramic support by twisting of the ceramic support (an operational position.

One configuration of the attachment node allows for unrestricted movement of the ceramic support when in the second opening. In this embodiment, the first opening is a slot having side faces extending between a peripheral edge at an outermost portion of the peripheral portion and the second opening has at least one curved edge face terminating where the slot meets the second opening.

Another configuration of the attachment node is one that provides a more limited movement of the ceramic support when in the second opening. In other words, the ceramic support can be moved from the insertion position to the operational position, but movement is stopped in one direction by the configuration of the attachment node second opening. This limited movement is one directional such that the ceramic support can still be moved between the insertion and operational positions.

In this configuration, the first opening includes a slot having side faces extending between a peripheral edge face at an outermost portion of the peripheral portion. The second opening has a first slot portion intended to receive a portion of the ceramic support and a second slot portion angled with respect to the first slot portion and configured to receive a central portion of the ceramic support by twisting of the ceramic support. The orientation of the first slot portion with respect to the slot determines the extent of the rotation of the ceramic support. For example, if the first slot portion and slot are generally aligned, the rotation of the ceramic support can be about 90 degrees. However, if the slot is angled with respect to the first slot portion, the rotation could be limited to less than 90 degrees, for example only 45 degrees as detailed below.

Similar to the tab-containing attachment node described above, the peripheral portion of the attachment node employing a slot can include means to retain the ceramic support in either the second opening or second slot portion. The retaining means can include the bendable tab as well as a raised protrusion extending from a face of the peripheral portion.

The side faces of the slot can be generally parallel to each other or diverge inwardly toward the peripheral edge face of the peripheral portion.

The slot-containing attachment node can also include the feature of the invention, wherein the one-piece heater rack has at least one plate member as part of the peripheral structure, the plate member bendable with respect to the peripheral structure, and further wherein the peripheral structure having the arrays of attachment nodes is bendable with respect to the peripheral structure.

The embodiments of the attachment node that are tab-less or include a slot can also be used in a heater assembly as described above and in a method of heating as described above for the tab-containing attachment node. The various configurations of the heater rack in terms of bendable features, perforations, plate members, etc. can also be combined with the tab-less attachment nodes or the slot-containing attachment nodes.

### BRIEF DESCRIPTION OF THE INVENTION

FIG. 1 shows a plan view of a part of a heater rack of the prior art.

FIG. 2 shows the heater rack of FIG. 1 in a bent configuration with ceramic supports for supporting open coil resistance elements.

FIG. 3 shows a prior art attachment between a ceramic support and a coil for a heater.

FIG. 4 shows another arrangement of the heater rack assembly of FIG. 2.

FIG. 5 shows yet another arrangement of the heater rack assembly of FIG. 2.

FIG. 6 shows a schematic drawing of a clothes dryer having a heater as a part thereof.

FIG. 7 shows the heater of the clothes dryer of FIG. 6.

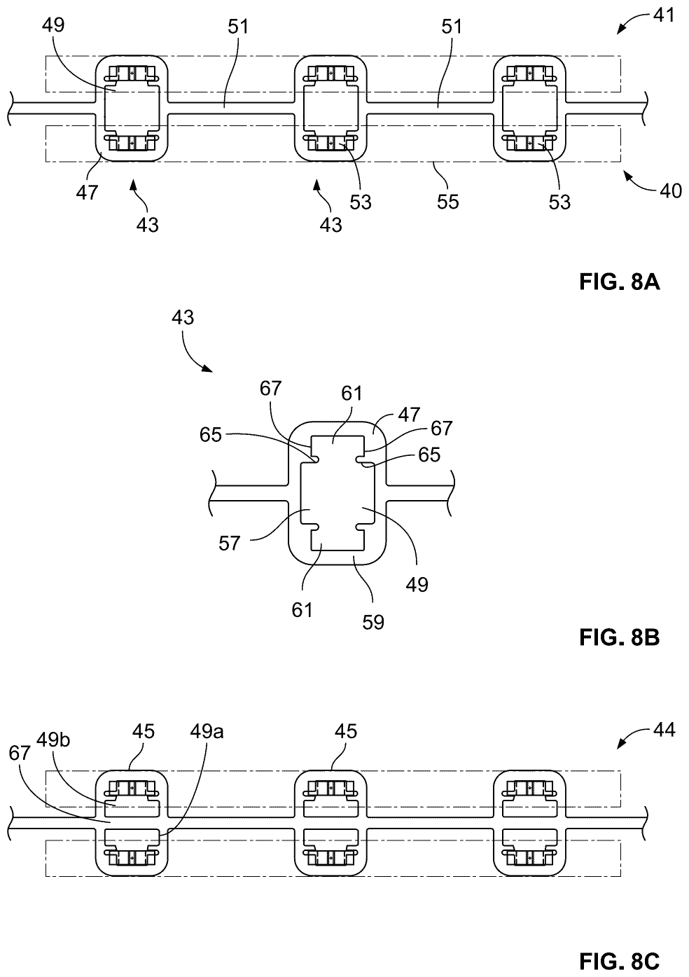

FIG. 8a shows a first embodiment of the invention as a part of a heater rack showing a number of ceramic support attachment nodes.

FIG. 8b shows an enlarged attachment node from the heater rack of FIG. 8a.

FIG. 8c shows a variation on the attachment node array of the heater rack of FIG. 8a.

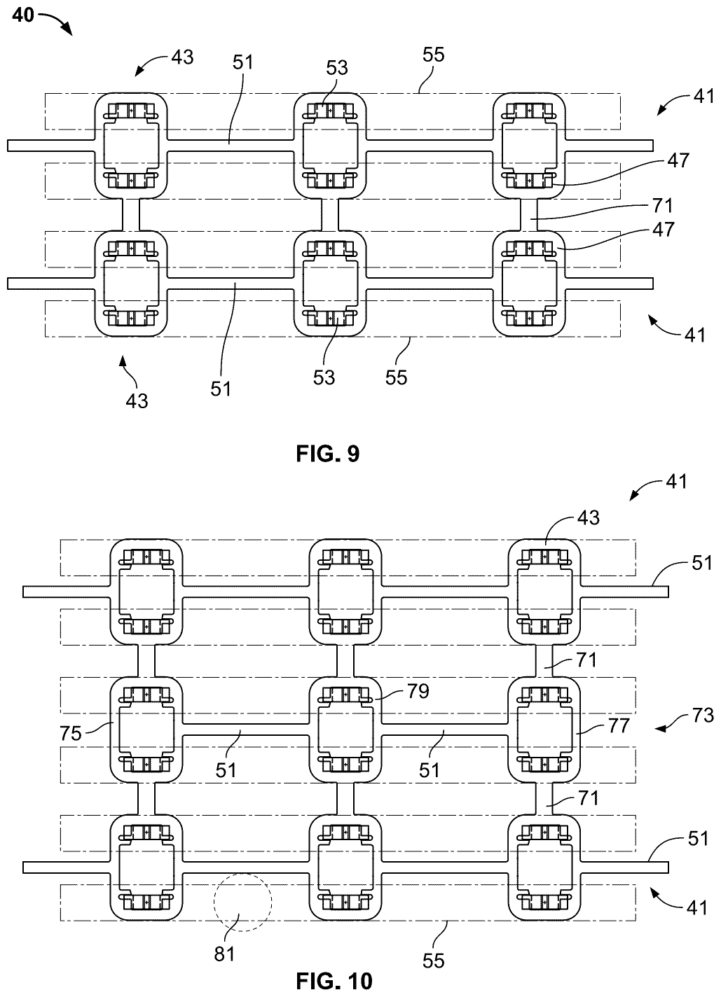

FIG. 9 shows another embodiment of the invention based on the heater rack of FIG. 8a.

FIG. 10 shows yet another variation of the embodiment of the invention based on the heater rack of FIG. 8a.

FIG. 11 shows a variation of the embodiment shown in FIG. 10.

FIG. 12 shows another embodiment of the inventive heater rack portion of FIG. 11.

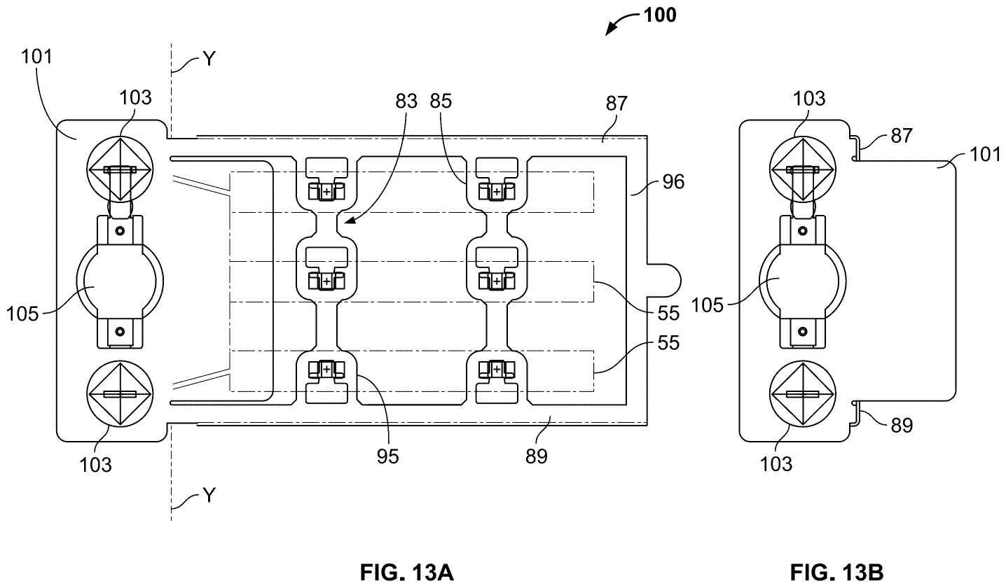

FIGS. 13a and 13b show a complete heater rack with a peripheral structure, which includes a plate member for heater component support.

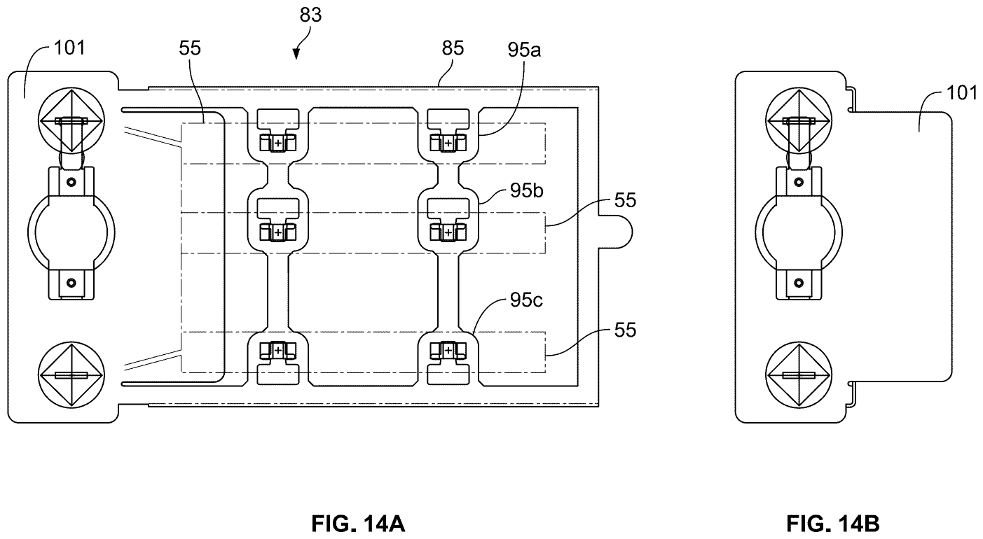

FIGS. 14a and 14b show a variation on the heater rack of FIGS. 13a and 13b.

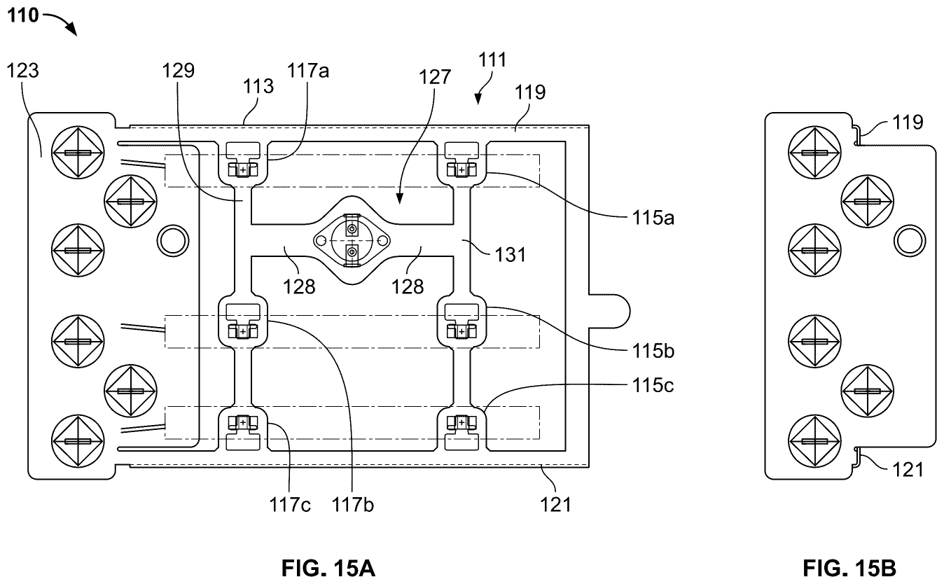

FIGS. 15a and 15b show a heater rack similar to that of FIGS. 14a-b but for the thermostat mounting location.

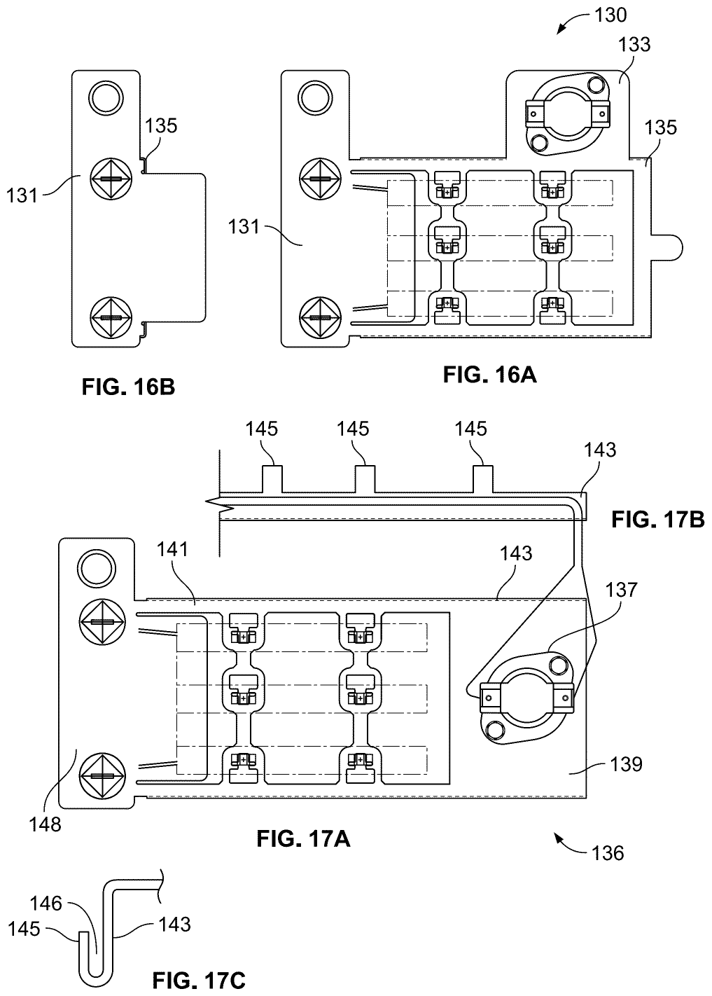

FIGS. 16a and 16b show a heater rack with an alternative thermostat mounting location as compared to FIGS. 15a and 15b.

FIGS. 17a-17c show another heater rack embodiment including a feature to accommodate heater component wiring.

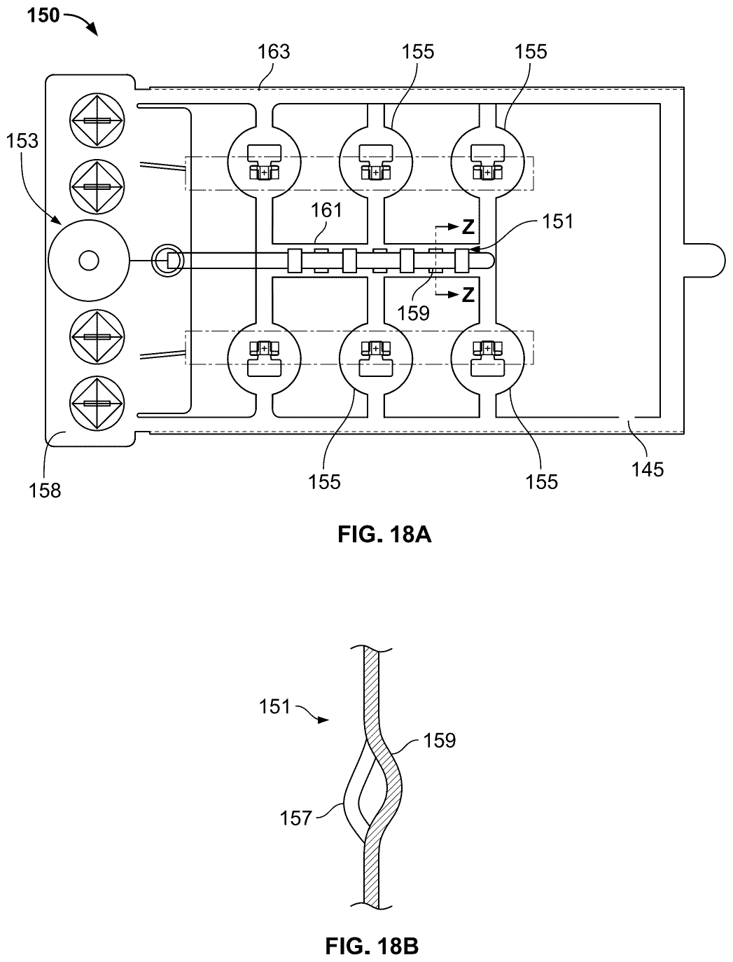

FIGS. 18a and 18b show yet another heater rack embodiment using a temperature limit device.

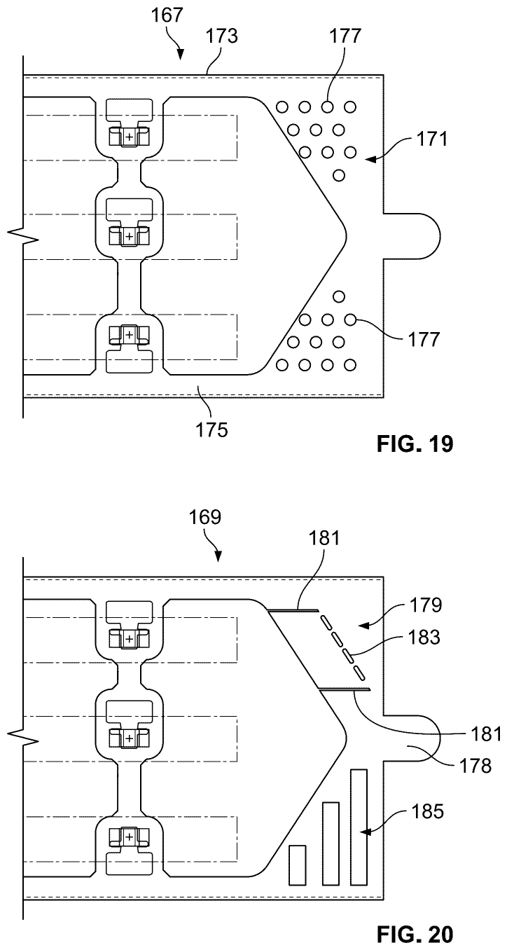

FIG. 19 shows a portion of a heater rack with a peripheral end member with air control features.

FIG. 20 shows a portion of a heater rack with a peripheral end member with other kinds of air control features than shown in FIG. 19.

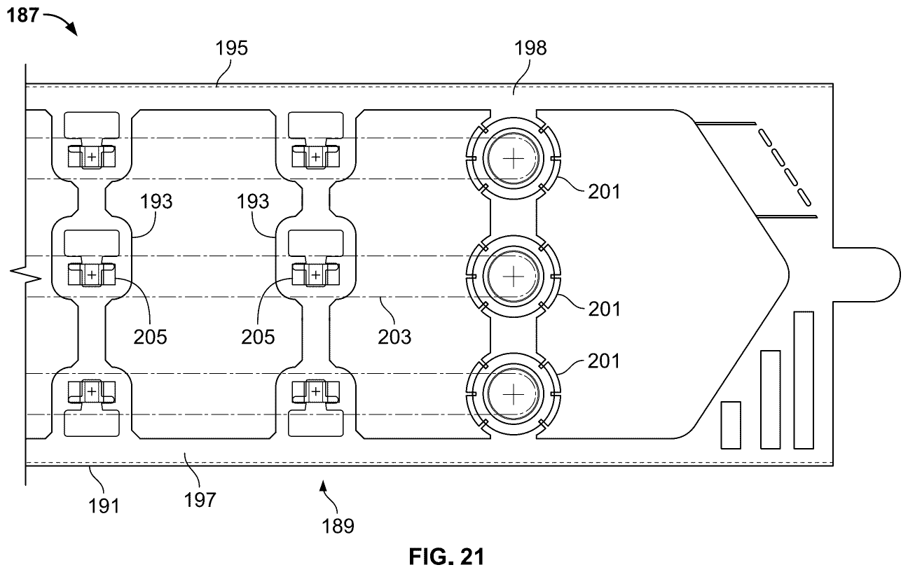

FIG. 21 shows a heater rack combining different kinds of coil ceramic supports.

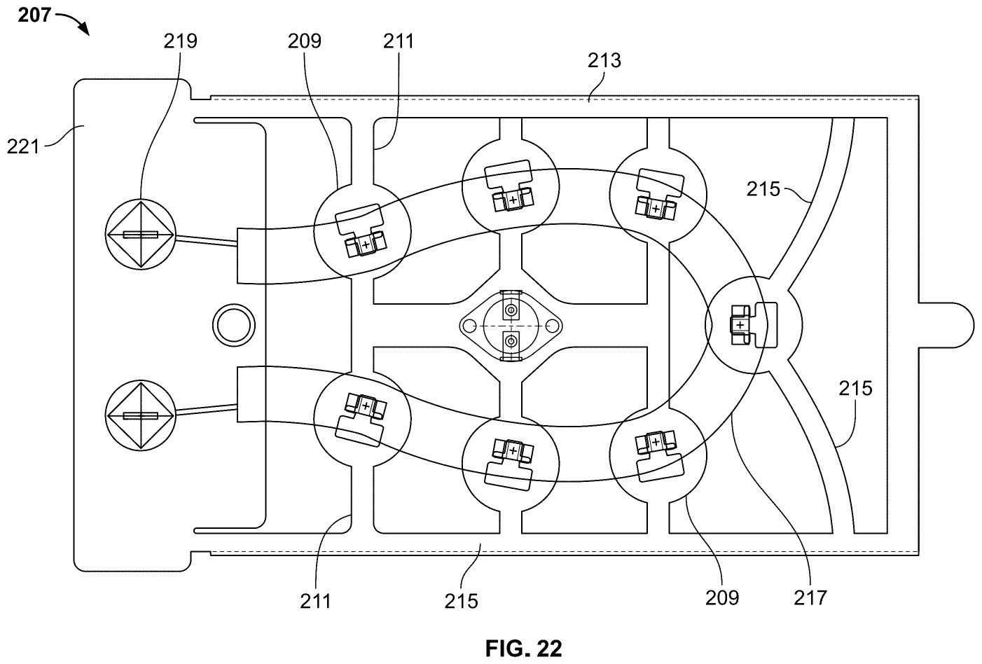

FIG. 22 shows a heater rack showing an alternative coil configuration.

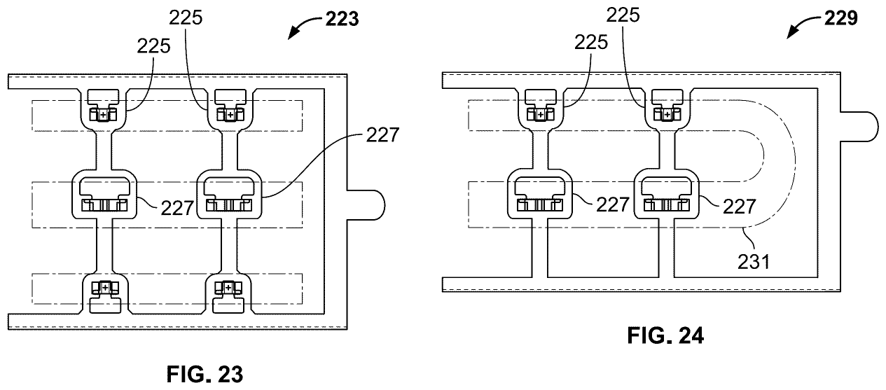

FIG. 23 shows a heater rack with different sized attachment nodes to accommodate different sized coils.

FIG. 24 shows a heater rack with different sized attachment nodes to accommodate one coil of varying size.

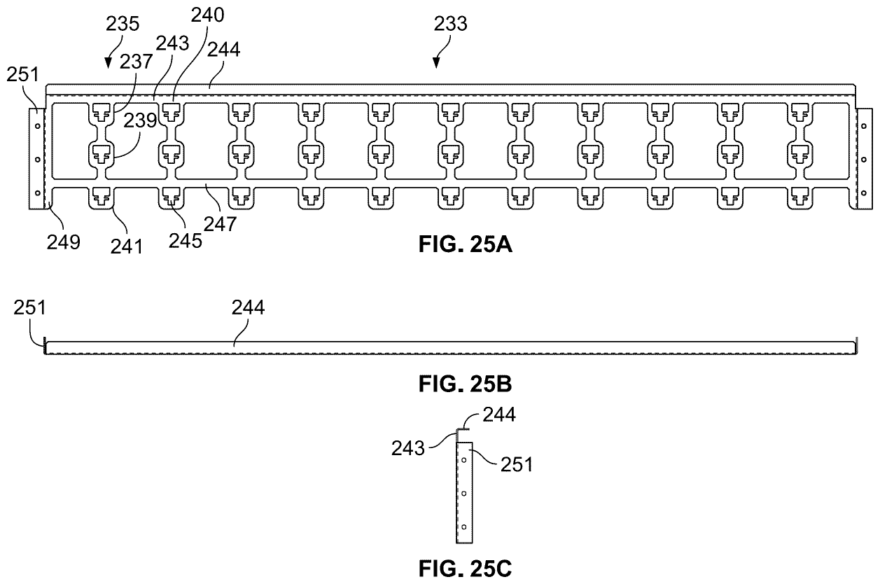

FIGS. 25a-25c show another embodiment of a less complex inventive heater rack.

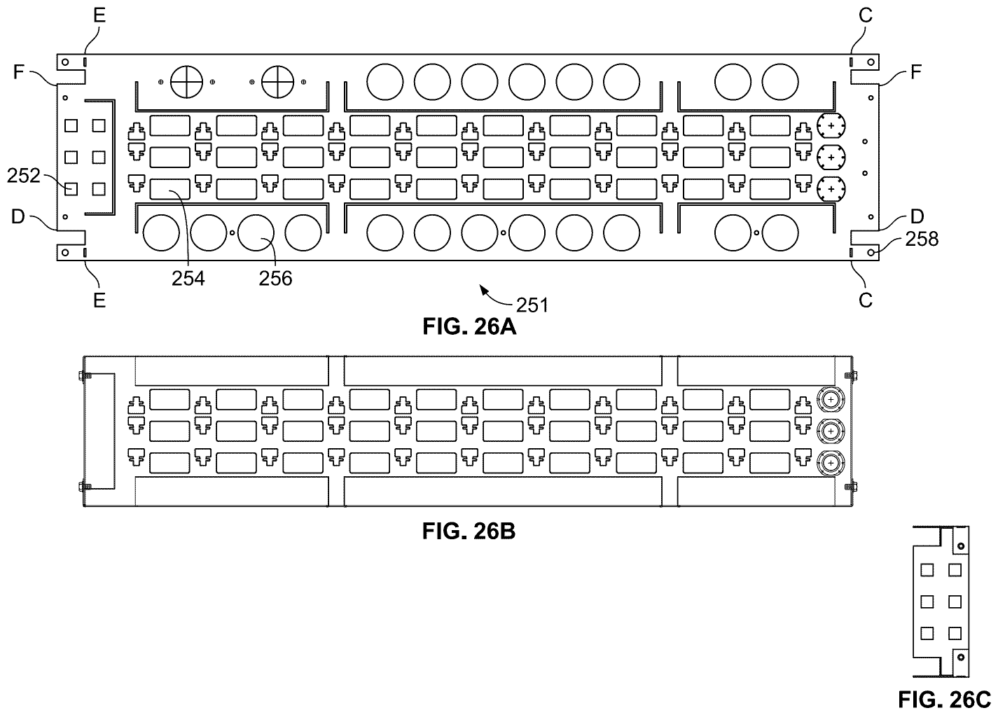

FIGS. 26a-c show another embodiment of the inventive heater rack with a more complex design.

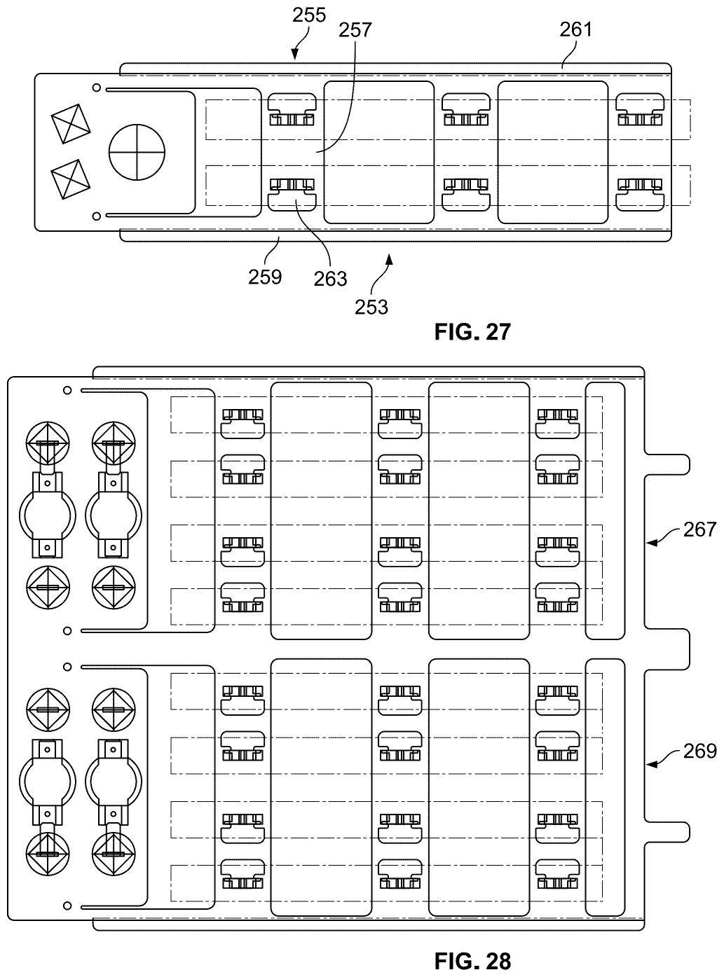

FIG. 27 shows another embodiment of the inventive heater rack with a more robust configuration for the arrays of attachment nodes.

FIG. 28 shows a variation on the heater rack of FIG. 27.

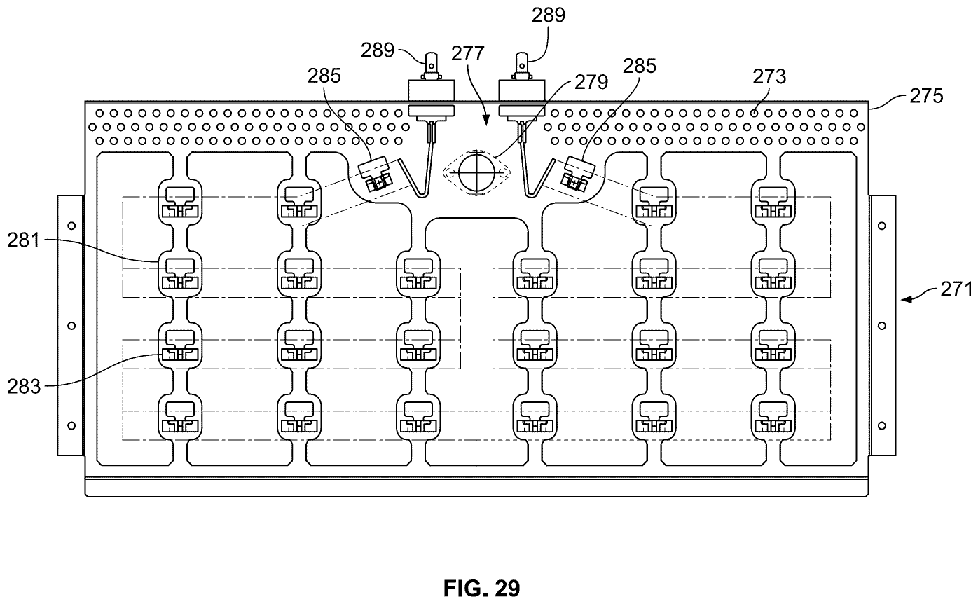

FIG. 29 shows another embodiment of the inventive heater rack with a combination of air flow control features and differently aligned attachment nodes.

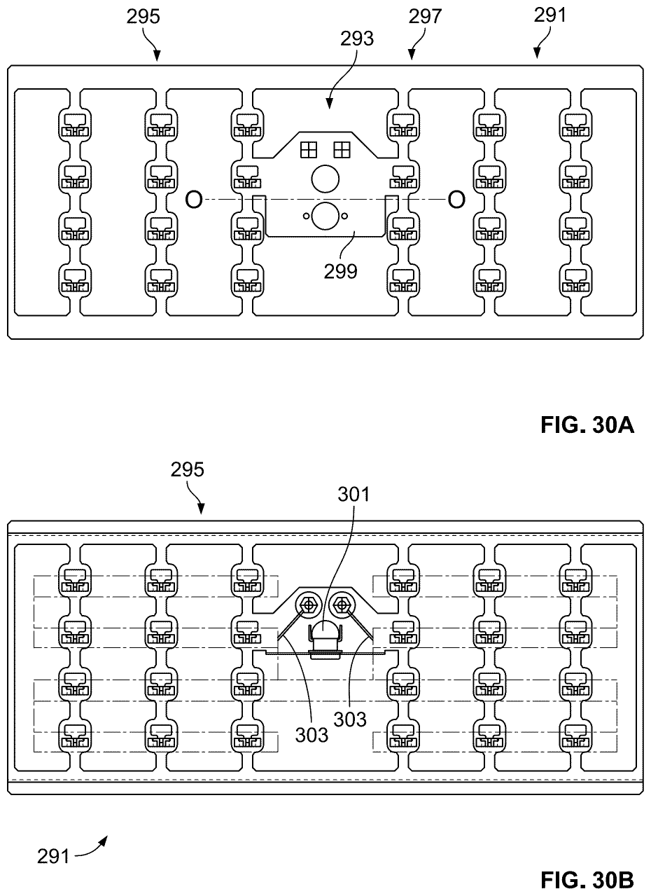

FIGS. 30a and 30b show another embodiment of the inventive heater rack with specially-mounted thermostat.

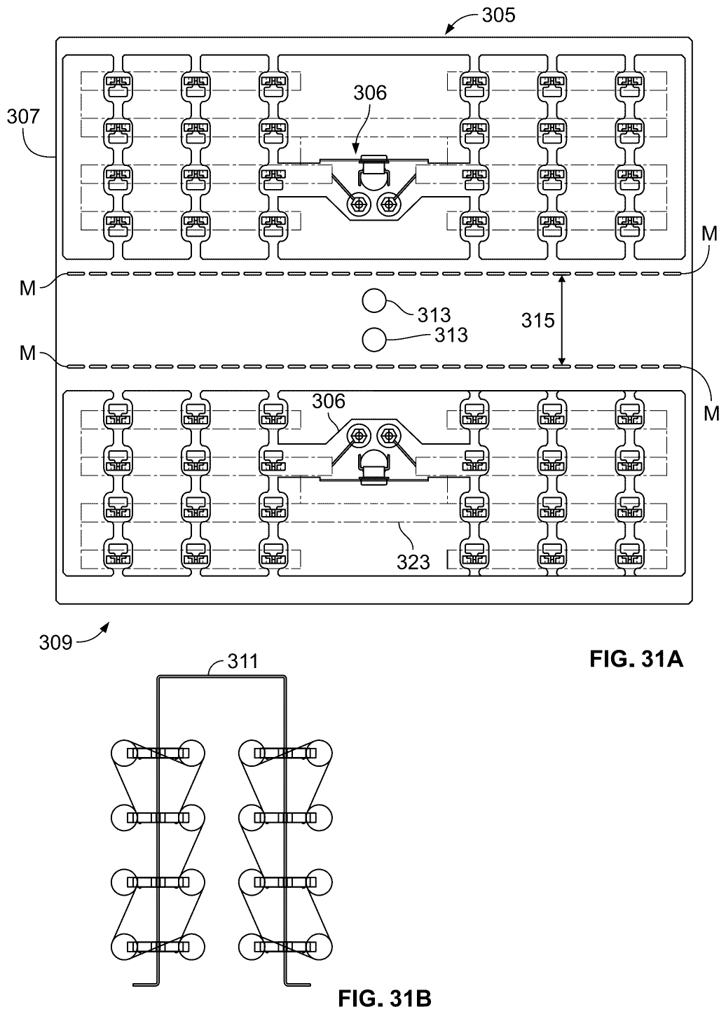

FIGS. 31a and 31b show another embodiment of the inventive rack heater with a folded configuration.

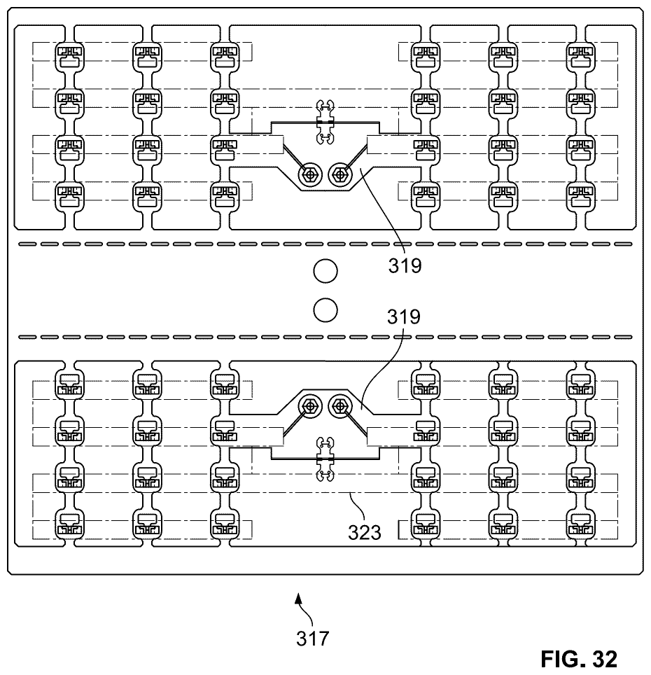

FIG. 32 shows a variation on the inventive heater rack of FIGS. 31a and 31b.

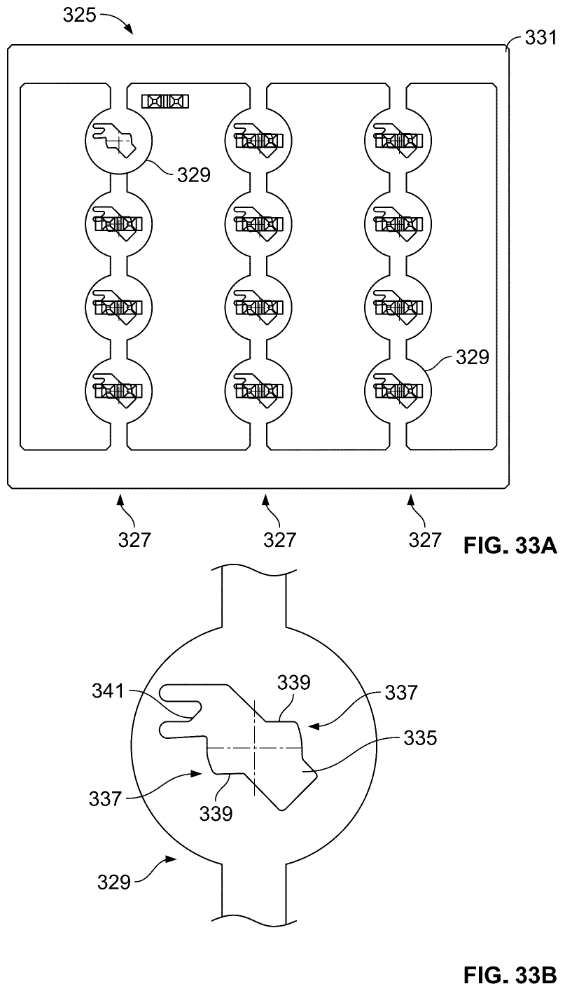

FIGS. 33a and 33b show another mode of attachment of the ceramic supports to the attachment nodes.

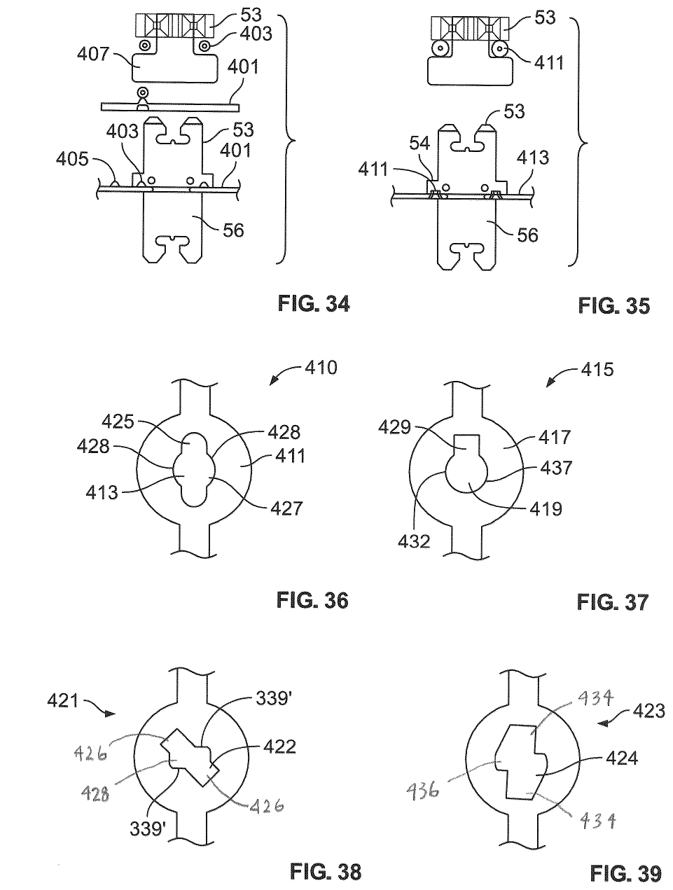

FIG. 34 shows a ceramic support attachment node connection from a top and side view with one kind of a mechanical means for holding the ceramic support in place.

FIG. 35 shows a ceramic support attachment node connection from a top and side view with another kind of mechanical means for holding the ceramic support in place.

FIG. 36 shows a top view of an attachment node without a mechanical means or arrangement associated with the attachment node for preventing rotation of a ceramic support once engaged in the attachment node.

FIG. 37 shows a top view of another kind of attachment node without a mechanical means or arrangement associated with the attachment node for preventing rotation of a ceramic support once engaged in the attachment node.

FIG. 38 shows a top view of yet another kind of attachment node without a mechanical means or arrangement associated with the attachment node for preventing rotation of a ceramic support in a direction that would permit ceramic support disengagement from the attachment node.

FIG. 39 shows a top view of an alternative kind of attachment node as compared to the attachment node of FIG. 38.

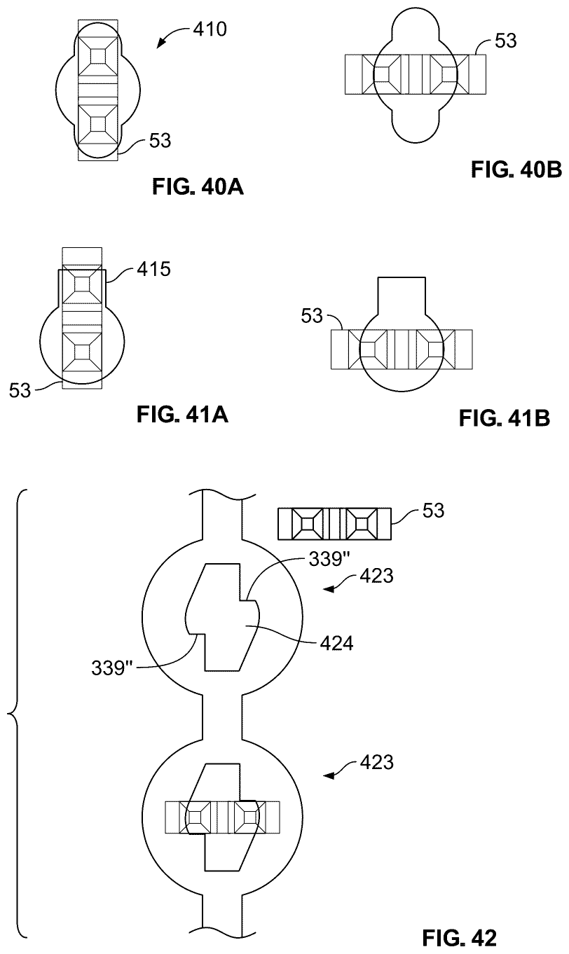

FIGS. 40A and 40B show a schematic drawing of movement of a ceramic support between insertion and operational positions.

FIGS. 41A and 41B show another schematic drawing of movement of a ceramic support between insertion and operational positions for an attachment node of different configuration as compared to FIG. 40A.

FIG. 42 shows an attachment node array in top view showing a limited anti-rotation feature as part of the attachment node opening configuration.

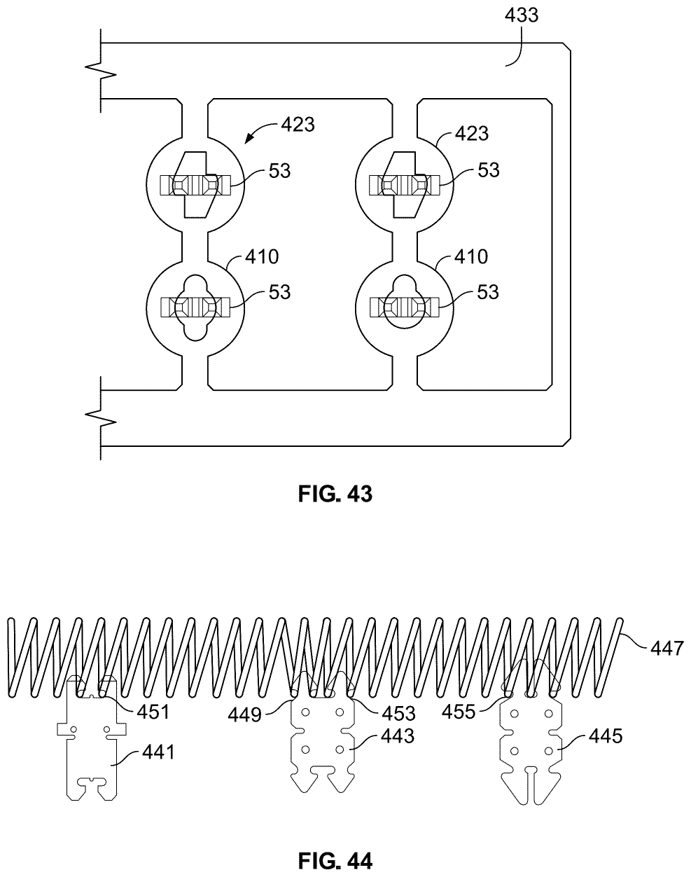

FIG. 43 shows a top plan view of a pair of attachment node arrays as part of the peripheral structure of a heater rack.

FIG. 44 shows different styles of ceramic supports engaged with a helical heating coil.

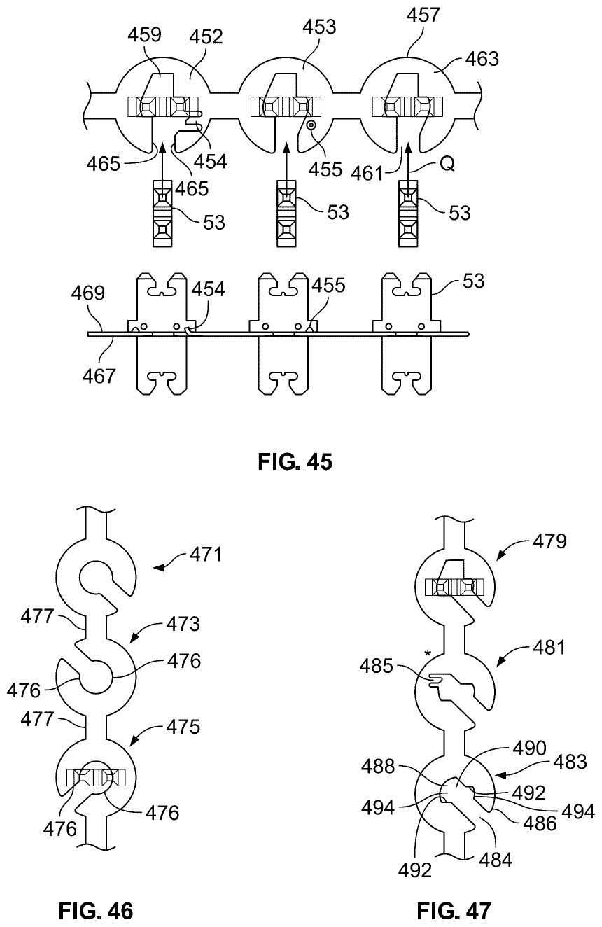

FIG. 45 shows a top plan view of an attachment node array wherein the peripheral portions of the attachment nodes include slots for ceramic support insert.

FIG. 46 shows a top plan view of an array of attachment nodes using different orientations for the slots of the attachment nodes.

FIG. 47 shows a top plan view of slotted attachment nodes, one including a locking feature to prevent ceramic support removal from the attachment node.

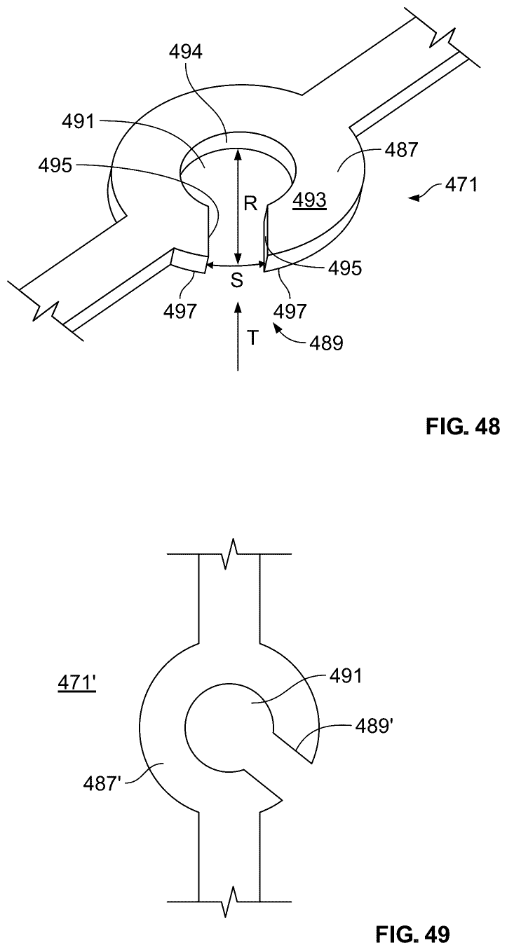

FIG. 48 shows an enlarged perspective view of an attachment node showing the slot configuration with greater detail.

FIG. 49 shows an alternative slot configuration for a slot-containing attachment node.

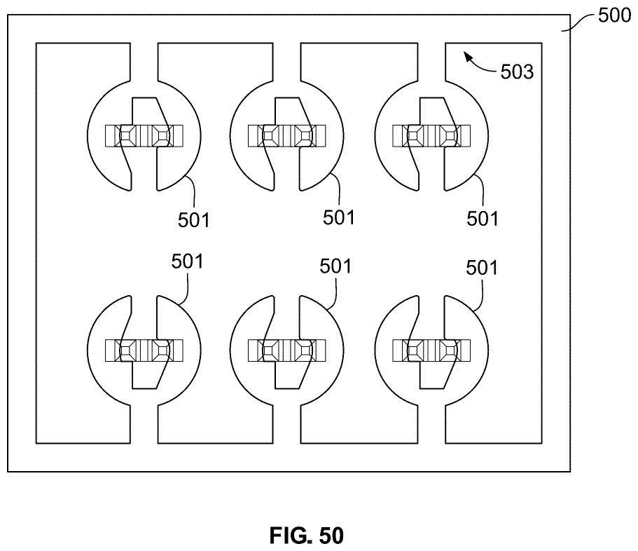

FIG. 50 shows a top plan view of an array of attachment nodes with ceramic supports in the operational positions.

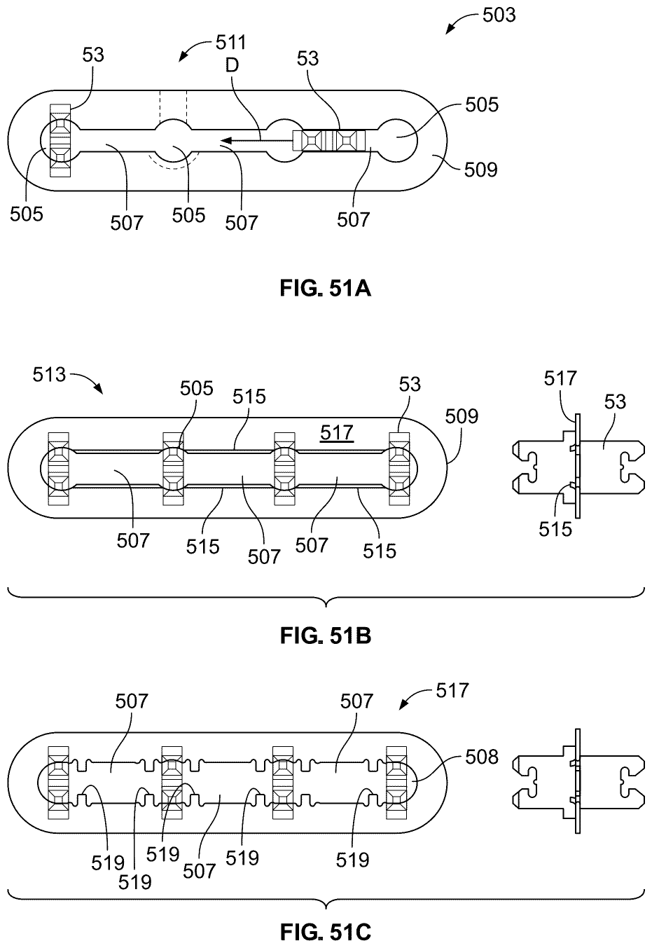

FIG. 51A shows a top plan view of another configuration of an attachment node using one slot opening interconnecting multiple openings for ceramic support twisting movement and operational position setting.

FIG. 51B shows an attachment node similar to that of FIG. 51A but with a locking feature to prevent movement of the ceramic support once in the operational position.

FIG. 51C shows an attachment node similar to that of FIG. 51B but with a different locking feature.

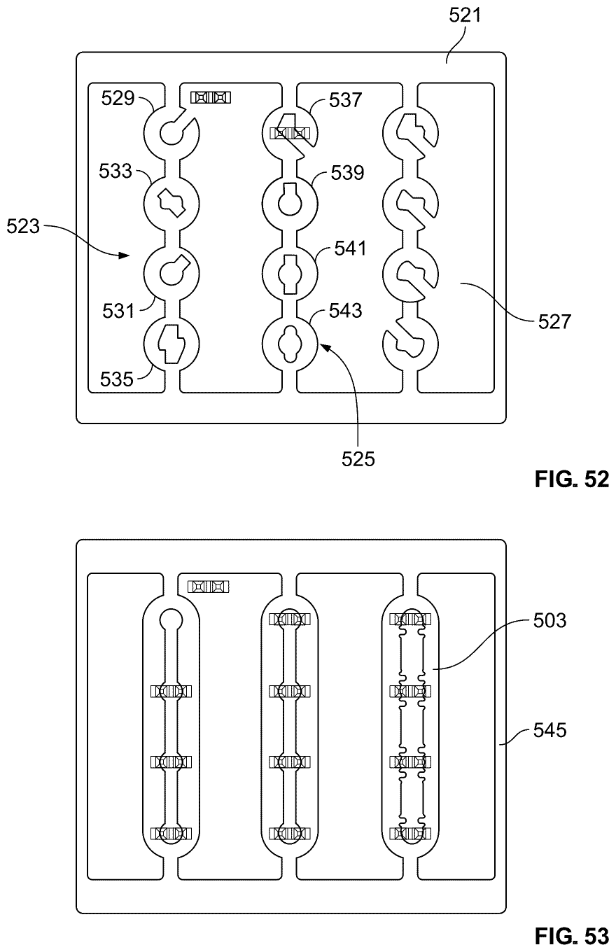

FIG. 52 shows a top plan view of arrays of attachment nodes with different configurations.

FIG. 53 shows a top plan view of arrays of the attachment nodes of FIG. 51A.

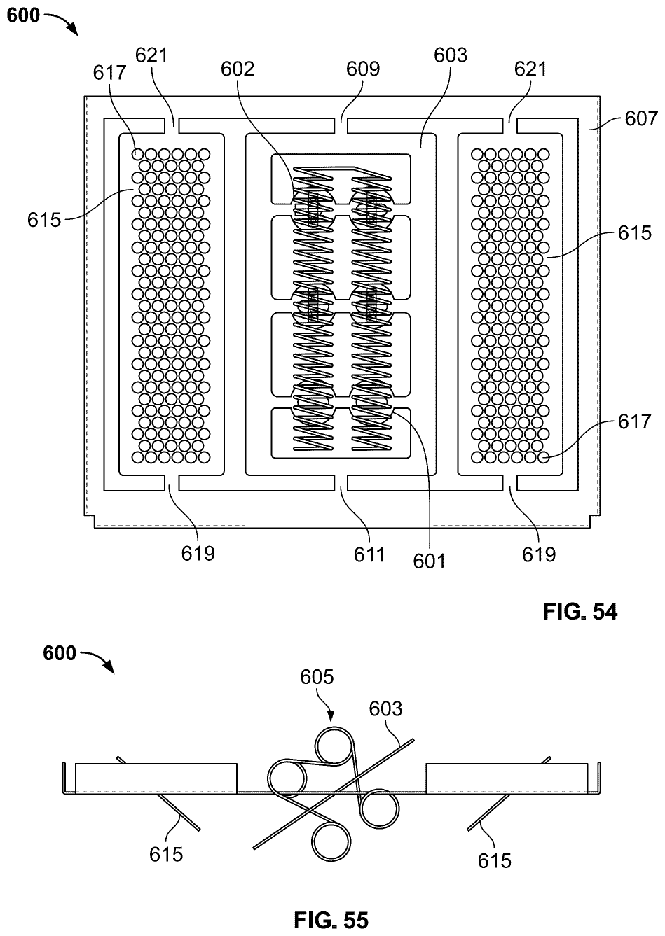

FIG. 54 shows a top plan view of another embodiment of the heater rack that includes a movable peripheral structure for changing the orientation of attachment nodes and movable perforation-containing plate members for changing their respective orientation.

FIG. 55 shows a side view of the embodiment of FIG. 54.

### DETAILED DESCRIPTION OF THE INVENTION

The inventive heater rack offers a number of advantages over the heater racks of the prior art. In contrast to many of the prior art heater rack designs, the inventive heater racks are configured to eliminate metal in areas where coils could sag and cause short circuiting. The inventive heater rack also eliminates the problem of tooling access to the nodes receiving the ceramic supports since such nodes can be accessed from the top of bottom side of the racks for ceramic support attachment as a result of a slide and lock or twist and lock configuration for the attachment nodes.

Making the heater rack of a single piece of material allows the creation of other areas on the rack to accommodate mounting of other heater components, permitting folding of certain parts of the heater rack to impart strength to the rack, and offer other mounting capabilities for heater components. This creation of other areas as an integral part of the rack also allows providing configuration in these other areas that assist in control of air flow over or through the heater rack.

One example of the inventive heater rack of the invention is shown in FIGS. 8a-8c. These figures address the attachment node aspect of the invention. Later figures illustrate the other features of the inventive rack in terms of adding other features to the heater rack to improve its capability in different heater applications.

FIGS. 8a and 8b show one embodiment of the invention as a portion of a heater rack in plan view. The portion of the heater rack shown in FIG. 8a is designated by the reference numeral 40. It should be understood that the heater rack includes peripheral structure beside that intended to attach to ceramic supports. The peripheral structure can include members forming a periphery of the rack and structure that provides support and/or places of attachment for other heater components that could be associated with the heater rack, e.g., thermostats, terminals, temperature limiting switches, and the like.

The heater rack is a one-piece structure that is made of a material sufficient to withstand the heating produced by a heater utilizing the rack. These materials can be any known materials used in heater racks supporting open type coil electrical resistance heating elements, e.g., sheet metal. The heater rack can be made in any way but a typical way is starting with a sheet material and performing one or more stamping steps on the sheet material to form the heater rack. Depending on the heater application, the heater rack may also be subjected to further working steps, e.g., folding parts of the rack, providing additional openings in the rack, e.g., forming a screw pocket and the like.

The heater rack portion 40 in FIG. 8a includes an array 41 of spaced-apart attachment nodes 43. The attachment nodes 43 include a peripheral portion 47 that creates an opening 49.

The heater rack portion 40 also includes a number of connecting arms 51. The connecting arms 51 extend between adjacent attachment nodes 43. At the end of the array 41, the connecting arms 51 would extend between the attachment node and another part of the heater rack structure, which could be a peripheral portion or a portion designed to support other heater components.

The heater rack portion 40 is also shown with ceramic supports 53 fixed to the attachment nodes 43 and coils 55 supported by the ceramic supports 53.

Referring to FIG. 8b, the opening 49 formed by the peripheral portion 47 of the attachment node 43 has dual functionality. In one mode, the opening 49 forms at least one space 57 that is sized to allow the ceramic support 53 to be fit into the space 57 from the top surface of the heater rack portion 40, designated by reference numeral 59, or the opposite or bottom side, which is not visible in FIG. 8b.

The opening 49 includes a second space 61. Space 61 is smaller in size as compared to space 57 and is designed to receive and retain the ceramic support 53 to the attachment mode 43. As shown in FIG. 3, a typical ceramic support is designed with a narrowed central portion or slots 19. The ceramic support 53 is similarly configured so that the ceramic support 53, once positioned in the space 57 is slid into the space 61 so that the slots of the ceramic support pass over the tabs 65 of the attachment node 43 and engage the edges 67 of the space 61. Once the ceramic support 53 is slid into space 61, the tabs 65 can be bent to secure the ceramic support 53 in place.

FIG. 8a shows the attachment node 43 with two spaces 61 so that two ceramic supports can be attached to the node 43 by being positioned in the space 57 and then slid and locked into place.

FIG. 8c shows a variation of the attachment node 43 as an array 44. In this embodiment, the opening 49 is divided into two separate openings 49a and 49b by cross arm 67. With this configuration, each ceramic support is positioned in the openings 49a and 49b and slid into the spaces 61 for attachment as described above.

The configuration of the attachment nodes in FIGS. 8a and 8c provide the advantage that the ceramic supports can be moved into place in the attachment nodes from either the top or bottom of the rack and there is no access problem for ceramic support attachment. Also, the position of the openings or space 57 and the space or opening 61 can be altered to change the position of the coil mounted to a ceramic support positioned in space or opening 61 and this difference in positioning is shown in FIG. 11 below.

Referring now to FIG. 9, the array 41 of FIG. 8a is combined with another array using the connecting arm 71. In this embodiment, the presence of the peripheral portions 47 of the attachment node 43 provides additional material to allow the connecting arms 71 to extend between adjacent attachment nodes. This then enables more attachment nodes to be used for a heater rack and provide more heating capacity, if needed.

FIG. 10 shows yet another variation of the heater rack of FIG. 8a. In this embodiment, another and limited array 73 of attachment nodes is positioned between the two arrays 41 and 44. Unlike the arrays 41, wherein the connecting arms 51 would ultimately connect to a peripheral structure of the heater rack, the end attachment nodes 75 and 77 only have connecting arms 51 that link to the attachment node 79 therebetween. With this embodiment, additional coil supports can be provided that do not necessarily extend the length of adjacent arrays of attachment nodes to give the heater design additional flexibility when configuring the heater and its coil arrangement. This embodiment also does not have the sagging problem and short circuit possibility mentioned above. In FIG. 10, a zone 81 is identified where the coil 55 may sag. There is no rack structure in zone 81 so that even if some sagging would occur, there is no metal present for contact with the coil and a short circuiting problem in zones where sagging may occur is avoided.

By having the peripheral portion as part of the attachment node, the attachment node or nodes can also be directly linked or be part of a periphery of the heater rack that is configured to provide strength to the heater rack and mounting capabilities. Referring to FIG. 11, two arrays 83 and 85 of attachment nodes are shown positioned between two peripheral members 87 and 89 of the heater rack itself. A segment 91 of each of the peripheral members 87 and 89 form part of the opening 93 of the attachment nodes 95. The peripheral members 87 and 89 could include a folded part represented by the dashed line, the folded part providing additional strength to the heater rack as well as mounting capability. With this arrangement, a single one-piece rack can be made that provides both coil support, and strength and mounting capability without the need to add other parts to the heater rack itself.

Also, the attachment nodes 95 can be configured differently along a given array, the second openings receiving the ceramic supports positioned so that the ceramic support 96 positions the coil 94 away from the peripheral member 89 to avoid short circuit protection. If the attachment nodes were all configured the same way, the coil 94 would be positioned over the peripheral member 89 and short circuiting could occur with coil sag.

As noted above, the different arrays of attachment nodes ultimately terminate as some peripheral part of the heater rack itself. FIG. 11 actually shows one embodiment of this wherein the arrays 83 and 85 terminate at the peripheral members 87 and 89 of the heater rack.

It should also be noted that the attachment nodes 95 are designed to hold one ceramic support. This differs from the configuration in FIGS. 8a-8c, wherein a given attachment node can be configured to hold two ceramic supports. While FIGS. 8a-8c hold two ceramic supports, the attachment node could be configured to hold more than two ceramic supports if so desired by adding additional spaces to receive the ceramic support in the embodiment of FIG. 8c.

FIG. 12 shows the heater rack portion of FIG. 11 with an additional peripheral member 98, which allows for more flexibility in terms of mounting the heater rack in a given heater.

FIGS. 13a and 13b show a completed heater rack 100, based on the embodiment of FIGS. 11 and 12. In this embodiment, the end of the peripheral members 87 and 89 not attached to the peripheral member 98 includes a plate member 101. As described above, the entire heater rack is stamp formed to form a planar heater rack with the attachment nodes, connecting arms, peripheral members and plate member. The plate member 101 can be bent at the line Y-Y in FIG. 13a so that it is perpendicular to the plane of the remaining part of the heater rack 100 as is shown in the end view of FIG. 13b. The plate member can provide a mounting surface for heater components, for example, terminals 103 and a thermostat 105.

These components are only examples and any heater component could be mounted to the plate 101. The heater rack 100 of FIGS. 13a and 13b is simply made by stamping the heater rack and bending, no welding or use of fasteners is required.

The heater rack of FIGS. 13a-13b also allows for the flexibility of changing the position of the coils being supported by the heater rack. In FIGS. 13a and 13b, the attachment nodes 95 are arranged such that the spacing between coils is generally uniform. However, the heater rack could be made with the attachment nodes 95 of the arrays with different relative spacing.

In FIGS. 14a and 14b, the attachment node arrays 83 and 85 each have three attachment nodes 95a, 95b, and 95c. Attachment nodes 95a and 95b are arranged in the heater rack to be closer together, thus creating a larger gap between attachment nodes 95b and 95c. This flexibility allows the positions of the coils to be shifted from one position to another to accommodate areas of air flow that may be higher or lower for the heater application.

The use of the plate member in FIGS. 13a and 13b also provides an advantage in terms of minimizing waste when making the inventive heater rack. Unlike other heater rack designs that can end up with a large amount of wasted material, retaining one or more plate members when making the heater rack reduces material waste and contributes to a manufacturing costs saving while at the same time providing functional area on the heater rack for various functionalities like mounting heater components, configuring the plate members for air flow control, etc. The inventive heater rack also allows flexibility in terms of locating a thermostat. In certain heater applications, it may be preferred to not have the thermostat at an end of the heater rack as shown in FIGS. 13a to 14b. Referring now to FIGS. 15a and 15b, another variation of the inventive heater rack is shown and designated by the reference numeral 110. In this embodiment, two arrays 111 and 113 of unevenly spaced attachment nodes 115a-c and 117a-c are provided between peripheral members 119 and 121. A plate member 123 is provided similar to that shown in FIGS. 13a to 14b.

Between the two arrays 111 and 113 is a thermostat attachment node 127, which extends between the connecting arms 129 and 131 between the attachment nodes 115a and 115b and 117a and 117b. The node 127 includes a pair of connecting arms 128 that extend between connecting arms 129, 131 of the arrays 111 and 113. In certain heater applications, it may be desirable to have the thermostat somewhere in the conditioned air space and the inventive heater rack configuration allows this flexibility. While a thermostat is shown positioned between the arrays 111 and 113, other heater components could be mounted where the thermostat is shown.

FIGS. 16a and 16b show another way to mount a thermostat using the inventive heater rack. This heater rack is designated by the reference numeral 130 and includes not only a plate member 131 on an end of the rack but also a second plate member 133 that is made part of the peripheral member 135. Here, the thermostat is mounted in a location that is previously been recognized as difficult to mount due to prior art heater rack designs.

When a thermostat or other heater component requiring wiring to be run along the heater rack is used, the peripheral parts of the heater rack can also be configured to provide support for wiring. Referring to FIGS. 17a-17c, a heater rack 136 is shown with a thermostat 137 mounted on a plate member 139. Similar to the rack portion shown in FIG. 11, the peripheral member 141 has a folded down part 143. Referring to FIG. 17b, this folded down part 143 can include securement tabs 145. The securement tabs 145 can be folded as shown in FIG. 17c to form a channel 146 to hold wires extending from the thermostat or other wire-bearing component of the heater. With this heater rack configuration of FIGS. 17a-17c, the folded down part provides a radiant barrier to protect the wires along their routing. Although not shown, the plate member 148 would be folded like the plate member 131 in FIGS. 16a and 16b.

What FIGS. 14a-17c show is the ease with which coils could be moved around to suit the equipment and its performance. Typical prior art methods used to produce this same kind of performance involve the configurations and usage of many different individual parts to hold the support ceramics in place. These methods make the assembly very difficult and time consuming, where using this new method is simple and requires only the one uniquely designed part. As well, the fact that the structure is already provided as the heater rack, it is simple to include safety devices and or monitoring devices into the design. With prior art racks, e.g., those shown in the above-noted U.S. Pat. Nos. 6,433,318 and 6,600,141 to Danko et al., this would have required many different individual components having to be made separately and assembled together and these prior art methods are greatly simplified by using the inventive heater rack.

In addition to providing structure to position a heater component like a thermostat in the area where the attachment nodes reside, see for example, FIG. 15a, FIG. 18a shows a heater rack 150 that uses a screw pocket 151 to hold a linear temperature limit device 153 symmetrically between the attachment nodes 155 and coils held thereby. The linear temperature limit device 153 has a gas filled bulb that senses temperature along its length. The screw pocket is shown in more detail in FIG. 18b, where it has alternating and spaced apart segments 157 and 159 that cooperate to hold the temperature limit device 153 in place and maintain an electrical clearance. The placement of the screw pocket 151 is similar to that of the thermostat shown in FIG. 15a. That is, a connecting arm 161 is positioned between the attachment nodes in the arrays of attachment nodes extending between the peripheral members 163 and 165 of the heater rack 150. The switching portion of the device 153 is shown mounted to the plate member 158 but it could be mounted elsewhere on the heater rack or even remote from the heater rack.

With the center location of the temperature limit device, the device would function symmetrically, which would allow the heater rack 150 to be positioned in a number of orientations while still maintaining the functionality of the temperature limit switch. The inventive heater rack also allows the device 153 mounting without the need for any additional structure, welding, fastening, and the like.

Besides providing structural support by folded part and plate members for component mounting, the peripheral structure of the heater rack can also be used to better control air flowing through or flowing over the heater rack. Air flow can always be a concern in HVAC equipment but with the inventive heater rack design, the rack itself can be made with features to assist in controlling air flow, such features do not require the use of other parts and extra steps involving welding, fastening, or the like.

Referring now to FIGS. 19 and 20, portions of heater racks 167 and 169 are shown. For heater rack 167, the peripheral plate member 171 that terminates the two peripheral members 173 and 175 includes a plurality of openings 177 distributed over the plate member surface. By providing the plate-like member 171 with openings instead of just a peripheral elongated member like shown in FIG. 18a, air flowing through the heater rack can be influenced. While the openings are shown as circular in shape, virtually any type of openings can be used to enhance the control of air flow for a given heater application.

Referring to FIG. 20, other features that can be incorporated into a plate peripheral member of a heater rack include a foldable deflector. In FIG. 20, the rack 169 has a plate member 178 that has a foldable member 179 as a part thereof. When forming the rack 169, the plate member 178 can include slots 181 and a perforated line of relief holes 183. The foldable member 179 can then be bent at the perforated line 183 to create a baffle to direct air in a given direction. With the relief holes, the foldable member 179 can be easily bent by hand. The location of the foldable member 179 in FIG. 20 is only exemplary and other configurations of a foldable member and locations could be used as part of the heater rack.

FIG. 20 also shows another shape and arrangement of openings 185 for air flow control. With the area provided by the plate members 171 and 178 in FIGS. 19 and 20, this area can be easily customized for a given heater application for air flow control, but without the need for welding, using other components, and the like. The one-piece heater rack only needs to be configured with openings, foldable members, or combinations thereof for a desired air flow enhancement. The advantage of the FIG. 20 embodiment is that using the combination of the deflector 179 can control air flow over the heater rack and the openings 185 can provide control of air flow through the heater rack. This dual air flow control is provided with only the parts of the heater rack itself, no other individual parts are required that would require further attachment to the heater rack.

The unique attachment nodes of the inventive rack can also be combined with conventional designs to support coils. FIG. 21 shows a portion 187 of a heater rack similar to that shown in FIG. 20. The portion 187 of a heater rack has arrays 189 and 191 of attachment nodes 193 extending between peripheral members 195 and 197. Also included is an array 199 of string-through style coil supports 201 like those shown in the Engelke patent mentioned above. With this combination of coil supports, the coil 203 held by ceramic supports 205 can pass through the coil support 201 if the heater designer would prefer having the string-through supports at the end of the coil travel on one side of the heater rack.

By virtue of the forming of the heater rack from a sheet of material by stamping or the like, the alignment direction of the attachment node array can be altered. While the arrays shown in FIG. 9, for example, are linear, the attachment nodes could be located so that the travel of the coil takes a non-linear path. Referring to FIG. 22, a heater rack 207 similar to the one shown in FIG. 15a is illustrated. Heater rack 207 has a number of attachment nodes 209 and corresponding connecting arms 211 that extend orthogonally from the peripheral members 213 and 215. The openings in the attachment nodes 209 are offset or angled from the longitudinal axis of the array containing the attachment nodes, this offset or angling allowing the coil 217 to travel in a non-linear path. Other connecting arms 215 with an attachment node 209 therebetween are provided and angled with respect to the peripheral members 213 and 215 so that the attachment node 209 is positioned properly to impart the necessary bend in the coil 217 to direct it back to the terminal 219 on plate member 221. As with the other embodiments, merely forming the rack with the necessary shapes of the connecting arms and attachment nodes allows for endless configurations to configure one or more coils in a desired orientation.

Beside varying the location of the attachment nodes, the size of the attachment nodes can be changed in a given heater rack. FIG. 23 shows a portion 223 of a heater rack having a first set of attachment nodes 225 and a second and larger set of attachment nodes 227. With this arrangement, differently-sized coils, e.g., 0.500 inch and 0.750 inch in diameter, can be combined in one heater rack.

Also, the different sized attachment nodes can accommodate a change in coil size for one coil as shown in the heater rack portion 229 of FIG. 24. Here, attachment nodes 225 support a portion of coil 231 and the larger attachment nodes 227 support the same coil 231 along its changed diameter length.

FIGS. 25a-c show an example of heater rack 233 that has eleven connected arrays 233 of attachment nodes 237, 239, 241. In this embodiment, each of the attachment nodes 237 has a segment 240 of the peripheral member 243 aiding in forming the opening 245 designed to receive a ceramic support. The peripheral member 243 also includes a folding part 244. The heater rack 233 also includes end peripheral members 249 and their foldable part 251. The attachment node 241 and the connecting arms 247 actually form another peripheral structure of the heater rack. FIG. 25a shows the rack before forming any folded part. FIG. 25b shows a side view having the peripheral member 243 after folding. FIG. 25c shows an end view, where the peripheral member 249 is folded. The heater rack 233 exemplifies a simple rack design that can hold 33 ceramic supports and support a considerable length of coil without having metal supports present in the heater rack where coil sag could occur.

With the inventive rack design, not only can simple designs be made as shown in FIGS. 25a-c but very complex designs such as that shown in the heater rack 251 shown in FIGS. 26a-c. The heater rack 251 is shown in the unfolded state in FIG. 26a and is folded along lines C, D, E, and F to form the heater rack shown in FIG. 26b with the end view shown in FIG. 26c. This design includes the arrays of attachment nodes and peripheral structure like the other racks described above. The openings 252 can be used for wire routing and terminals, the openings 254 between the arrays of attachment nodes allow for air flow through the rack, the openings 256 can serve as mounts for heating components like thermostats as well as providing control of air flow over the heater rack. The holes 258 on the corners of the heater rack 251 can be used to receive fasteners and the like once the heater rack is folded in its usable configuration. The openings 254 also create the space between the second openings in the attachment nodes that hold the ceramic supports and absence of structure of the heater rack to provide an opportunity for short circuiting if the coil should sag between the ceramic supports.

FIG. 27 shows an alternative attachment node array design. In other designs shown above, e.g., FIG. 17a, the attachment node is positioned between connecting arms wherein the connecting arms are more narrow in width as compared to the attachment nodes. In FIG. 27, the rack 253 has attachment node arrays 255 that are formed of a uniformly shaped arm 257 positioned between the peripheral members 259 and 261, with the required opening 263 for the attachment node formed in the arm 257. In this embodiment, the structure between the peripheral members is more robust given the larger sized arm. While the arrays in FIG. 27 only contain two attachment nodes, more than two attachment nodes should be positioned in the arms 257 and a rack 265 could be configured with two heater racks 267 and 269 combined together as shown in FIG. 28.

Another example of a custom design heater rack is shown in FIG. 29 and designated by the reference numeral 271. This heater rack combines a number of features described above such as air flow openings 273 in one of the peripheral members 275 of the heater rack 271. The peripheral member is also configured with a plate area 277 to mount a thermostat 279. The heater rack 271 also includes arrays of attachment nodes 281, which are the type to hold just one ceramic support 283. Also, there are attachment nodes that are not linearly aligned, i.e., nodes 285, which are located in the plate area 277 to allow the coil 287 to properly terminate at terminals 289. In this heater rack, the coil spans only the front or top side of the rack and the thermostat 279 is wired from the back side of the rack to avoid radiant heat issues.

Yet another example of a heater rack is shown in FIGS. 30a and 30b and is designated by the reference numeral 291. The heater rack is shown in its flat or planar configuration in FIG. 30a without showing the coil and its coil run and its folded configuration as shown in FIG. 30b with the coil being depicted in dashed lines. Referring to FIG. 30a first, a plate member 293 is provided between the two middle arrays 295 and 297 of the attachments nodes. The plate member 293 is configured to mount a thermostat and terminals. The plate member 293 is also shaped so that a portion 299 can be folded along line O-O. When the portion 299 is folded, see FIG. 30b, a thermostat 301 is mounted thereto such that the thermostat can be positioned directly above the middle of the coil. Also, coil terminating wiring 303 can be routed out the back of the plate member 293. This is another example of a custom heater rack configuration that can be easily manufactured from a single sheet of material.

The heater rack 291 shown in FIGS. 30a and 30b can be made in a folded configuration as shown in the heater rack 305 of FIGS. 31a and 31b. This heater rack is similar to that of FIGS. 30a and 30b with the use of the centrally located thermostat mounting, which is designated as 306 in FIG. 31a. However, the heater rack 305 is made with basically two rack sections 307 and 309, each of which being like the configuration of the heater rack 291. The two sections are separated by a plate section 311, the plate section including openings 313 and relief holes 315. The openings 313 allow for wiring to pass through the openings and be routed away from the coils and radiant heat. The relief holes 315 allow the heater rack 305 to be bent or folded along lines M-M so as to create the configuration shown in FIG. 31b. With this style of heater rack, the heater rack, made of one piece can be assembled with the rack sections 307 and 309 facing each other so that the heater rack has a u-shape as shown in FIG. 31b.

FIG. 32 shows a variation on the heater rack of FIGS. 31a and 31b. In this Figure, the heater rack is designated by the reference numeral 317 and includes plate sections 319 similar to the plate sections 306 in FIG. 31a. Instead of a thermostat mounting, a ceramic support 321 is mounted to each plate section 319 using either the attachment node configuration of the invention or a conventional one. With this configuration, if the heater design would have the coil 323 span a distance that could cause sagging or other problem, the ceramic support 321 can engage a portion of the coil for support. Again, this variation is accomplished still using just a single one-piece heater rack and does not require any welding, extra fastening or fasteners, or the like.

FIGS. 33a and 33b show an alternative to the slide and lock attachment described above for the attachment nodes, see FIGS. 8a-c. FIG. 33a shows a simple heater rack designated by the reference numeral 325. The rack 325 includes a number of arrays 327 of attachment nodes 329, a peripheral structure 331, and ceramic supports 333. One attachment node 329 is shown without the ceramic support attached thereto and FIG. 33b shows the attachment node enlarged to show more detail. Instead of the slide and lock feature, attachment node 329 uses a twist and lock feature. Referring to FIG. 33b, the attachment node has an opening 335 that includes a rectangular shape that allows the ceramic support to be inserted into the opening 335 from the top or bottom of the heater rack, which is similar to the positioning of the ceramic support shown in FIGS. 8a-8c. The ceramic support 333 is inserted into the opening 335 so that the central part of the ceramic support is aligned with the plane of the attachment node 329. The opening 335 also includes two notches 337. The notches 337 allow the ceramic support to be twisted so that the edges 339 of the notches engage the grooves that would be located in the central part of the ceramic support 333. The opening 335 also includes a locking tab 341, that is designed to be bent once the ceramic support is twisted. The bent locking tab 341 prevents a reverse twist of the ceramic support and possible release from the attachment node 329. The twist and lock feature of FIGS. 33a and 33b provide the same advantage as the slide and lock feature explained in FIGS. 8a-8c in that the ceramic support can be secured to the attachment node from the top or bottom side of the rack; access from an edge or side of the attachment node is not required for ceramic support attachment.

As described above, the heater rack of the invention can be considered a base part of a heater assembly, wherein the heater rack provides mounting locations for the ceramic supports that hold the coils of the heater assembly and various heater assembly components like terminals, temperature limit switches, thermostats and the like. The heater rack can then be mounted using the peripheral structure in a given device or apparatus that requires the use of a heater rack assembly or mounted to the device or apparatus using some intervening components linking the peripheral structure and the device and apparatus.

The heater rack can be used in virtually any method that requires conditioning of a space using a heated fluid like air. Examples include heating air flowing through ducts, heating air in an appliance like a clothes dryer, and other known methods where heating using open type coil electrical resistance elements is provided.

While the embodiments described above for the inventive heater rack employ a bendable tab, other mechanical means than a tab can be employed to keep the ceramic support in place. As described above, the ceramic support is inserted into the first opening in the attachment node. Once inserted, the ceramic support is moved, either by twisting or sliding so that the central portion of the ceramic support engages a part of the attachment node. The tab is then bent to keep the ceramic support in place after its sliding or twisting movement.

FIGS. 34 and 35 each show top and side views of alternative mechanical arrangements or means to keep the ceramic support in place once engaged in the attachment node of the heater rack. In FIG. 34, a tab-less heater rack is designated by reference numeral 401 and shown engaging a ceramic support 53. The heater rack employs the sliding opening configuration as seen in FIGS. 8A and 8b. The heater rack 401 is shown with a pair of dimples 403 formed in the heater rack, the dimples 403 extending above a surface 405 of the heater rack 401. The dimples 403 are positioned in the heater rack 401 so that once the ceramic support 53 is inserted into the opening 407 and forcibly slid into the second opening 409 and over the dimples 403, the raised configuration of the dimples 403 prevents movement of the ceramic support out of the second opening 409, the dimples securing the ceramic support in place in place of having a tab that requires bending.

FIG. 35 shows another alternative to the use of a tab to keep the ceramic support in place. In this embodiment, an extrusion technique is used to form an extruded protrusion 411 in the heater rack 413. The extruded protrusion provides more material above the plane of the heater rack 413 to provide a more robust structure to keep the ceramic support in place.

While the alternative embodiments shown in FIGS. 34 and 35 provide a more efficient mechanical means to secure the ceramic support in place since a tab bending step is eliminated, a passive structure that does not require a further securing step such as the tab bending, the ceramic support must ride over the dimple or extruded protrusion and this contact can possibly cause damage to the ceramic support. Thus, it would be ideal to be able to retain the ceramic support in the opening of the attachment node without the need for a mechanical means or feature that would prevent the ceramic support from being disengaged from the attachment node.

Another embodiment of the invention responds to this need by providing a means to secure the ceramic support in the heater rack without the need for any mechanical fastening feature or features that would be part of the heater rack, regardless of whether the feature is a tab, dimple, extruded portion, or, in fact, any other configuration of the heater rack that would employ some kind of a mechanical stop to prevent the ceramic support from being rotated with respect to the opening it sits in for coil support and heater operation (an operational position) to a position where the ceramic coil could again move to its insertion position and fall out of the opening designed for insertion. While it is true that the embodiment of FIGS. 33A-33B has the attachment node configured to prevent a certain extent of rotation by including stopping faces that engage the ceramic support after a certain degree of rotation, this rotation stopping feature only prevents rotation in one direction, e.g., counterclockwise. The lack of absence of a mechanical means associated with the attachment node is one wherein the attachment node is configured to allow the ceramic support to rotate between its insertion position wherein the ceramic support is first inserted into the attachment node and an operational position, wherein the ceramic support is twisted from the insertion position to the operational position. Lacking an outside influence on the ceramic support itself, the invention attachment mode can allow the ceramic support to freely move between its insertion position and its operational position. The outside influence that keeps the ceramic support in its operational position despite no mechanical feature that prevents its movement to the insertion position is discussed in more detail below.

FIGS. 36-39 are examples of one type of attachment node that does not use any mechanical feature that is part of the attachment node to prevent movement of the ceramic support between its insertion position and its operational position. These embodiments contrast with the embodiments above that use a bendable tab, dimple, extruded protrusion and prior art techniques like the tine configuration of Holmes, wherein the attachment node requires the use of a pronged slot that expands to receive the ceramic support, the pronged end of the attachment node retaining the ceramic support in place once inserted into the slot of the attachment node.

FIGS. 36 and 37 shows one type of attachment node that does not restrict rotation of the ceramic insert at all with FIGS. 37 and 38 having an attachment node configuration that provides a limited rotation of the ceramic support once inserted into the opening of the attachment node, but still does not prevent movement of the ceramic support between its insertion position and operational position.

Referring to FIG. 36, the attachment node is designated by reference numeral 410 that has a peripheral portion 411 that completely surrounds the specially configured dual functioning opening 413. The attachment nodes shown in FIGS. 37-39 also employ an attachment node configuration that has a peripheral portion that completely surrounds the opening of the attachment node.

While not shown, it should be understood that the attachment node 410 as well as the other attachment nodes shown in FIGS. 37-39 can be arranged in virtually any fashion as part of the heater rack, much like the attachment nodes described above that employ either the sliding or twisting movement of the ceramic support. For clarity purposes, just one attachment node is illustrated.

FIG. 37 shows an attachment node 415 that also a peripheral portion 417 and specially configured opening 419. The functionality of the specially configured openings 413 and 419 are described below in illustrations including the ceramic support.

FIGS. 38 and 39 illustrate attachment nodes 421 and 423, respectively. The difference between the attachment nodes 413 and 419 in FIGS. 36 and 37 and the attachment nodes 421 and 423 is the extent of the rotation of the ceramic supports once the ceramic support is inserted into the opening of the attachment node. In FIG. 36, the opening 413 has a slot-like shape, which is designated by reference numeral 425, the slot as a first opening for ceramic support insertion including an enlarged central portion 427 having opposing curved edge faces that receive the ceramic support when moved into its operational position. In FIG. 37, the opening 419 has a slot portion 429 and a portion 431, also having a curved edge face 432, the slot and portion 431 open to each other.

Once the ceramic support is inserted into the slot 425 (FIG. 36) or the slot portion 429 and portion 431 (FIG. 37), the ceramic support can freely twist or rotate in a 360 degree fashion while the central portion of the ceramic support either engages the enlarged central portion 427 with its curved edge faces 428 or portion 431 with its curved edge face 432. Either attachment node in FIGS. 36 and 37 allows free rotation of the ceramic support, including between the insertion position and operational position.

FIGS. 40A-B and 41A-B show the movement of the ceramic support in the attachment nodes 410 and 415 of FIGS. 36 and 37 between an insertion position and operational position. It should be noticed from FIG. 35 that the ceramic support has stops 54 and one end designated as reference numeral 56. It is end 56 that is inserted into the openings of the attachment node, with the stops 56 engaging the heater rack. In FIG. 40A, the ceramic support 53 is inserted into the opening 413. The ceramic support can then twist by virtue of its narrowed central portion, see the slot 19 in FIG. 3, the slot allowing the twisting motion as shown in FIG. 40B. In FIG. 40A, the ceramic position is shown inserted into the opening 413 and representing an insertion position. FIG. 40B shows the ceramic support 53 twisted 90 degrees to be in the operational position. The attachment node 415 has no mechanical feature that prevents movement between the insertion and operational positions.

The attachment node 415 allows the same twisting motion as shown in FIGS. 41A and 41B, with the insertion position shown in FIG. 41A and the operational position shown in FIG. 41B. The difference between the attachment nodes 410 and 415 is the configuration of the openings 413 and 419. However, the same functionality is provided in that the openings 413 and 419 provide enough of a slot to allow the ceramic support to be inserted into the opening and an enlarged portion either as the enlarged opening 427 or the partially circular opening 431 to allow the twisting movement of the ceramic support. Again, it should be understood that the attachment nodes 410 and 415 allow for a 360 degree rotation of the ceramic support once engaged in the attachment node.

In contrast to this full 360 degree rotation movement, the attachment nodes 421 and 423 of FIGS. 38 and 39 allow less rotational movement of the ceramic support. The attachment node of FIG. 38 is like the attachment node of FIGS. 33A and 33B but without the bendable tab 341. While the attachment nodes of FIGS. 38 and 39 are similar to the attachment nodes in FIGS. 36 and 37, they do have the rotation stop feature shown in FIG. 33A and FIG. 33B to prevent some rotation of the ceramic support when it is engaged in the attachment node, Referring to FIGS. 39 and 42 and attachment node 423, the rotation of the ceramic support in the opening 422 is limited by the faces 339′. In this attachment node, the ceramic support is twisted 90 degrees from the insertion position until the faces 339′ come into play and prevent any further counterclockwise movement once the ceramic support is in the operational position as the lower illustration in FIG. 42.

Referring back to FIG. 38, since the opening 422 is angled as compared to the more vertical orientation of the opening 424 shown in FIG. 42, the degree of twisting is only 45 degrees when the ceramic supported is inserted into the opening 422 and twisted to the operational position (not shown). Put another way, the slot portions 426 of the opening 422 that are positioned on either side of the second opening 428 that receives and retains the ceramic support are at a 45 degree angle with respect to the long axis of the second opening. In contrast, in FIG. 39, the slot portions 426 are in general alignment with the second opening 436, such that the ceramic support is rotated 90 degrees to the operational position. This same kind of rotation difference is also present in the embodiment described below, wherein the slot in the peripheral portion takes the place of one of the slot portions in the closed attachment nodes of FIGS. 38 and 39.

FIG. 42 is also an example of a pair of attachment nodes 423 in series as part of a peripheral portion that is in turn part of a heater rack. In FIG. 42, one attachment node 423 is shown with its opening 424 empty and the other attachment node is shown with the ceramic support inserted and twisted so as to be in the operational position to engage a helical coil.

The openings 413, 419, 422, and 424 are all examples of openings that allow for both insertion of the ceramic support into the attachment node and twisting movement to position the ceramic support out of the portion of the opening that allows for insertion. However, other opening configurations can be utilized that provide enough opening space to allow the ceramic support to be inserted and another smaller opening space that allows edges of the smaller opening space to engage the central portion of the ceramic support so as to prevent it from dropping out of the heater rack.

FIG. 43 is an example of combining different attachment nodes together in a peripheral structure 433. Notably, this arrangement does not have any means as part of the attachment node itself, no prongs, tabs, dimples, etc., to prevent the ceramic supports from moving in the clockwise direction for attachment nodes 423 and in any direction for attachment nodes 410.

This heater rack embodiment of the invention that includes one or more attachment nodes, i.e., one that does not employ any mechanical means or arrangement as part of the heater rack attachment node or heater rack itself to prevent the ceramic support from freely moving from its insertion position to its operational position, is still functional in terms of a heater operation employing the inventive heater rack. The reason for this functionality is that the ceramic supports that are engaged in the attachment nodes of a heater rack are also linked to a helical heating coil that is part of a heater employing the heater rack. The helical heating coil is held by each ceramic support that is engaged in the attachment nodes. At the same time, the coil also binds the ceramic supports together. This binding of the ceramic supports together prevents the ceramic supports from turning either clockwise or counterclockwise, for example, attachment nodes 410 and 415, which do not have any faces to prevent movement in one direction, or clockwise, for example, attachment nodes 421 and 423, which are configured with counterclockwise rotation prevention stopping faces.

The functionality of maintaining the ceramic supports in place using the helical heating coil can be enhanced if so desired by selecting heavier gauge sizes for the heating coils, e.g., gauge sizes of #14 to #20. The heavier gauge sized heating coils have higher strength and tend to bind the ceramic supports together more tightly. Another enhancement feature is to arrange the attachment nodes and their associated ceramic supports in a way to increase the tension on the helical coil.

FIG. 44 shows a schematic of a number of different style ceramic support 441, 443, 445, engaging a helical heating coil 447. This drawing shows that the spacing between adjacent ceramic supports can be changed, thereby creating more or less tension on the heating coil. More specifically, the distance between attachment points 449 and 451 of ceramic supports 443 and 441, respectively, is greater than the distance between attachment points 453 and 455 of ceramic supports 443 and 445, respectively, Thus, a greater tension on the helical heating coil is created between the ceramic supports 441 and 443, thus improving the engagement between the helical heating coil and ceramic supports and preventing unwanted twisting of the ceramic supports once engaged in the attachment nodes.

While the embodiments of FIG. 36-43 illustrate attachment nodes that include a peripheral portion that completely surrounds the opening in the attachment nodes that are configured to allow insertion of the ceramic support into the opening and then allow movement of the ceramic support to an operational position, the attachment nodes can also be configured such that the peripheral portion does not completely surround the opening that allows for both insertion of the ceramic position to its insertion position and movement of the ceramic support to its operational position. Since the helical heating coil holds the ceramic support in place as described above and eliminates the need for a mechanical means or arrangement to prevent the ceramic support from reverting to its insertion position and possibly drop out of the attachment node, the opening in the attachment node can include a slot in the peripheral portion. With the slot in the peripheral portion of the attachment node, the ceramic support can still be inserted from either planar side of the attachment node as is the case when the peripheral portion of the attachment node completely surrounds the opening used for insertion and movement of the ceramic support. With a slot in the peripheral portion, the ceramic support can be inserted into the attachment node opening from the side or edge of the attachment node rather than from one of the planar faces of the attachment node. The slot-containing attachment node aspect of the invention can include the embodiment described above for FIGS. 36-43, wherein there is no mechanical means to prevent the ceramic support from moving between the insertion and operational positions, and FIGS. 33A-B, 34, and 35, wherein a mechanical means such as a bendable tab, dimple, or extruded portion is used to prevent the ceramic support from moving between the insertion position and the operational position. While embodiments below will include a configuration of the opening in the attachment node that will prevent a partial rotation of the ceramic insert, e.g., prevent counterclockwise rotation when the ceramic support is moved into its operational position once inserted into the attachment node, this partial rotation prevention still allows rotation of the ceramic support in the clockwise direction, such movement then positioning the ceramic support back to its inserted position and allowing the ceramic support to be dislodged from the attachment node if no other outside influence is placed on the ceramic support, e.g., an engaged helical heating coil.

FIG. 45 shows an example of attachment nodes with slotted peripheral portions. In FIG. 45, one attachment node 452 is shown that similar to that of attachment node 423 but for the orientation of the slot with respect to attachment node interconnecting structure and the use of a bendable tab 454. Another attachment node 453 is shown that is also similar to attachment node 423 but it employs a dimple 455 as shown in FIG. 34. Yet another attachment node 457 like attachment node 423 but with a slot in the peripheral portion. As can be seen from FIG. 45, the ceramic support 53 can be slid in the direction Q to be put in the insertion position in the attachment node. The ceramic support 53 can be then twisted counterclockwise as shown in FIG. 45 and secured by the bendable tab 454, dimple 455, or, for attachment node 455, the helical heating coil when engaging the ceramic support.

In the attachment node embodiment of FIG. 45, there are essentially two openings, one as a slot portion 459 and another as slot 461 in the peripheral portion 463. These openings allow the ceramic support to be inserted from a side or edge of the attachment node using the slot 461 of the peripheral portion 463. The slot 461 does not perform any retention function to keep the ceramic support 53 from exiting the opening 459. Thus, it can have opposing parallel edges 465.

While FIG. 45 shows an insertion of the ceramic support from the side or edge of the attachment node, the ceramic support could also be inserted from either face 467 or 469 of the attachment node, this insertion utilizing the slot portion 459 and a portion of the slot 461.

While the attachment nodes 452, 453, and 457 are the type that permit a counterclockwise rotation feature, FIG. 46 shows slot-containing attachment nodes 471, 473, and 475 that are configured to allow for 360 degree rotation. The three different kinds of attachment nodes would be part of a peripheral structure, not shown but for the interconnecting members 477. Attachment node 475 is shown with a ceramic support in the operational position. FIG. 46 is an example of a heater rack with different attachment nodes as part of the same peripheral structure. In embodiment, the slot in the peripheral portion of the attachment node and a portion of the remaining opening in the attachment node create a first opening that allows for insertion of the ceramic support into the attachment node. The remaining part of the first opening, which can be considered a second opening, allows for rotation of the ceramic support via the curved edge face 476, see FIG. 46, engaging a central portion of the ceramic support for retention in the attachment node.

FIG. 47 shows another array of attachment nodes 479, 481, and 483, each including the counterclockwise rotation stopping feature. This array of attachment nodes also shows that one of the attachment nodes could include a mechanical means to secure the ceramic support in its operational position, in this instance, a bendable tab 485. Referring to the attachment node 483 in FIG. 47, which includes slot 484, the slot 484 terminating at an outer peripheral face 486 of the attachment node, this attachment node includes the partial anti-rotation prevention feature as noted in FIG. 39. In contrast to the embodiment of FIG. 39, wherein the opening 424 comprises a first opening that allows for insertion of the ceramic support and a second opening which allows for movement of the ceramic support for engagement with the attachment node, the slot-containing attachment node 483 uses a portion of the slot 484 for ceramic support insertion purposes along with a slot portion 488. Another slot portion 490, with the anti-rotation faces 492, acts as a second opening whose faces 494 engage the central portion of the ceramic support, the ceramic support then positioned in its operational feature.

FIGS. 48 and 49 show an enlarged portion of the attachment node in perspective view that includes a slot in the peripheral portion to better explain configurations thereof. The attachment node in FIG. 48 is designated by reference numeral 471 and it is one that allows for 360 degree rotation of the ceramic support once the ceramic support is moved into the insertion position, see FIG. 46. The peripheral portion is designated by reference numeral 487 and includes a slot 489 or a first opening. The slot 489 and second opening 491 form a distance R, that is such that the ceramic insert can be inserted into the opening 491 and slot 489 so that the ceramic support can be twisted to occupy the opening as shown in FIG. 46 for attachment node 475 and be in an operational position for heating coil engagement.

In this 360 degree rotation embodiment, the slot 489 being a first opening and the opening 491 being a second opening, the opening 491 is one that has a curved edge face 494 that extends from the termination of the slot faces 495 at the opening 491. The opening 491 is generally circular in shape but for the slot termination into the opening 491.

The slot 489 also has a width S that would be wide enough to allow the ceramic support to be inserted from the top face 493, or the opposite face of the attachment node to be in the insertion position. With the width S wide enough to have the body of the ceramic support inserted into the slot 489 and opening 491, the ceramic support can also be inserted in the direction T if so desired. While the slot width S could be sized so that the narrowed center portion of the ceramic support could slide in the slot from the T direction, it is preferred to have the slot width S be such that the body of the ceramic support can be inserted from either face of the attachment node. With this preferred slot width, the ceramic support can be inserted from either the face 491 or its opposite face or in the T direction.

In FIG. 48, the slot 489 has opposing edge faces 495, the edge faces generally parallel to each other. The edge faces 495 terminate at an outer peripheral face 497 of the peripheral portion 487. This termination of the edge faces 495 at the peripheral face 497 is at a location that is the outermost part of the attachment node 471. Put another way, the edge faces 495 follow a straight path between the opening 491 and the peripheral face 497. The configuration of the slot 489 is one that provides no impediment to movement of the ceramic support into the slot 489 along direction T.

While FIG. 48 illustrates a pair of slot edge faces that are generally parallel to each other, the slot configuration could be one that is shown in FIG. 49, that is a top view of an alternative kind of attachment node. In this attachment node 471′, the slot 489′ has edge faces 495′ that diverge inwardly from a center of the attachment node and towards the peripheral face or edge 497 of the peripheral portion 487′. The termination of the slot 489′ would still have the width S to allow for insertion from the top or bottom face of the attachment node. Since there is no need for any mechanical means to retain the ceramic support once in its operational position, the slot size at some portion along the slot length can effectively be larger than body of the ceramic support or its center portion and the ceramic support can still be twisted once in the opening 491 to the operational position. This open or uninhibited slot configuration contrasts with the prior art style, wherein the slot in the peripheral portion of the prior art attachment node narrows from the outer peripheral as part of the pronged tine so that the ceramic support cannot be removed from the attachment node once inserted into its opening.

FIG. 50 is an example of a peripheral structure with a plurality of individual attachment nodes as a part thereof. In contrast to earlier depictions of multiple attachment nodes that are connected in series, see FIG. 45 for example, FIG. 50 shows a peripheral structure 500 that has attachment nodes 501 extending from and along an inner periphery of the peripheral structure. While the attachment nodes are the slot-containing peripheral portion type that prevent counter-clockwise rotation, any type of attachment node could be employed as part of the peripheral structure 500.

The attachment nodes in connection with FIGS. 36-50 have a peripheral portion or slotted peripheral portion that surrounds the opening intended for the ceramic support to be positioned in the operational position. However, the peripheral portion that includes the opening for ceramic support insertion and movement to the operational position can be configured to with multiple openings to hold multiple ceramic supports as shown in FIGS. 51A-C.

In FIG. 51A, attachment node is designated by reference numeral 503 and it includes four openings 505, which are configured to allow for twisting movement of the ceramic support to be in the operational position. The attachment node 503 also includes slot portions 507 that are positioned between adjacent openings 505. FIG. 51A illustrates an exemplary insertion and movement of the ceramic support 53 for the attachment node 503. In this example, the ceramic support is inserted into one slot portion 507 and then slid in the arrow D direction to the opening 505 and twisted to be in the operational position. However, since the opening 505 is at least as wide as the slot 507, the ceramic support could also be inserted into part or all of the opening 505 and a portion of the slot 507 rather than inserting the ceramic support 53 entirely in the slot. As with the other attachment node embodiments described above, the openings 505 and arrangement of the slots do not prevent further twisting movement of the ceramic support such that it could move to one of the slot portions 507 and drop out of the attachment node. Such movement is prevented once the ceramic support engages a helical heating coil that would engage the ceramic support as described above. While the attachment node 503 is the type wherein the peripheral portion 509 surrounds the slot portions 507 and openings 505, it is also within the scope the invention to include one or more slots in the peripheral portion that would provide sliding access or face insertion access to the openings 505. An exemplary slot configuration is shown by reference numeral 511 and the dashed lines, mimicking the slot and opening arrangement of FIG. 48.

Referring now to FIGS. 51B and 51C, attachment nodes similar to that shown in FIG. 51A are illustrated. Unlike the free rotation embodiment of the attachment node that does not include any mechanical means for securing the ceramic supports in the operational position, FIGS. 51B and C show attachment nodes with locking features.

In FIG. 51B, an attachment node 513 is shown wherein the peripheral portion 509 includes a bendable lip 515 along each slot 507. On the right side of FIG. 51B, the ceramic support 53 is shown inserted from face side 517. Once the ceramic support is inserted into the slot or a portion of the slot 507 and opening 505 or portion thereof, the bendable lip is bent towards the face 517 as shown in the side view of FIG. 51B (the lip 515 could be bent the other way as well). The bent lips 515 then prevent the ceramic supports from moving from the operational position. show associated with each slot 507.

FIG. 51C shows another attachment node 517 that employs an alternative mechanical means to hold the ceramic supports in place. Instead of the bendable lip that extends along the slots as in FIG. 51B, tabs 519 are provided that extend into the slots 507. Once the ceramic supports are inserted into one of the attachment node slot portions 507 and then moved to opening 508 and twisted, the tabs are bent as shown in the side view on the right side of FIG. 51B to hold the ceramic supports in place.

FIGS. 52 and 53 are additional examples of attachment nodes and peripheral structure, showing the ability to combine different kinds of attachment nodes in one heater rack. In FIG. 52, a peripheral structure 521 is shown with three arrays of attachment nodes 523, 525, and 527. Array 523 combines attachment nodes with different capability. Slotting containing node 529 allows for free rotation capability of the ceramic support. Node 531 that also has free rotation but no slot, and two nodes 533 and 535 have the configuration for limit counterclockwise rotational movement in different degrees. Array 525 shows one slotted attachment node 537 that includes the counterclockwise limited movement and three other nodes 539, 541, and 543. Node 539 is one that has the slot terminate in the opening so that the slot and opening both function to receive the ceramic support. Nodes 541 and 543 have the opening for the operational position located between slots portions. The ends of the slot portions in node 543 are rounded whereas the ends of the slot portions in node 541 are squared off.

While the attachment node 503 in FIG. 51A is shown as a unitary structure, wherein the peripheral portion also acts as a peripheral structure, the attachment node 503 could also be connected to other attachment nodes of like construction so that the attachment node 503 would extend in series or be arranged in a parallel or side by side configuration. For example and referring to FIG. 53, the attachment nodes 503 could be arranged within a peripheral structure 545 so as to be in a side by side arrangement.

FIGS. 52 and 53 allow for a number of different possibilities for helical heating coil support. For example, nodes 529 and 537 would engage a helical heating coil with node 529 using the helical heating coil to keep it is place and node 537 also using the helical heating coil 537 but with the added restriction that counterclockwise movement of the ceramic support is limited.

Referring back to FIG. 19, embodiments of the heater rack are disclosed to manipulate air flowing over the heating racks to optimize performance. In FIG. 19, air tends to flow faster and with more volume in the area 171, thus the openings or perforations 177. As shown in FIG. 20, foldable deflectors 179 can be added with ease and they can be folded by hand as a result of the existence of the relief holes. In the alternative or in combination with the foldable deflectors, custom cutouts 185 can be provided.

FIGS. 54 and 55 provide an improvement in the manner in which the heater rack can be configured to optimize air flow and heater performance. One embodiment of the improved heater rack is shown in FIG. 54 as a top plan view and a front side view of the heater rack is shown in FIG. 55. The heater rack is designated by reference numeral 600 and array of attachment nodes 601 and 602 are shown positioned within a peripheral structure 603. The attachment nodes 601 and 602 are shown with ceramic supports 53 and a helical heating coil 605. The attachment nodes 601 and 602 are like those illustrated in FIGS. 37 and 36, respectively.

The peripheral structure 603 for the attachment nodes 601, 602 is linked to the heater rack periphery 607 at rotation zones 609 and 611. Since the peripheral structure is only attached to the heater rack periphery at rotation zones 609 and 611, the peripheral structure 603 can be rotated out of the plane of the heater rack as shown in FIG. 55.

In conjunction with a movable peripheral structure as part of the heater rack, the heater rack 600 includes a pair of movable plate members 615. Each plate member includes a plurality of through holes, perforations, or apertures to allow air flow through the plate members 615.

Each plate member is also movable with respect to the heater rack periphery 607 by the plate members being linked to the heater rack periphery 607 at zones 619 and 621. Thus, the plate members 615 can rotate with respect to the heater rack periphery 607 in the same manner as the peripheral structure 603 including the attachment nodes 601 moves or rotates and illustrated in FIG. 55.

Considering the capability of the plate members 615 and the peripheral structure 603 to rotate with respect to the heater rack periphery 67, the one piece heater rack can be designed to rotate the plate members and peripheral support at different angles with respect to the heater periphery 607. Thus, the perforations or through holes 617 of the plate member 615 and/or the attachment node-containing peripheral structure 607 that supports the ceramic supports and heating coil can be oriented to perform a particular task for the heating system. Reasons for changing air flow can include performance improvement, close quarter installation of the heater rack to allow fitting of the rack in a given location, and the like. The number of orientations of the peripheral structure and plate members is virtually limitless.

The heater rack of FIGS. 54 and 55 is just one example of a particular combination of plate member or members and a movable attachment node-containing peripheral structure. The heater rack could employ just one plate member rather than a pair as shown in FIGS. 54 and 55.

In addition, the heater rack could be designed with two or more inline movable peripheral structures, the two or more inline movable peripheral structures flanked by one or two plate members.

While the attachment nodes are shown with a generally circular shape with a peripheral edge face that has a curved or arcuate shape, the attachment nodes should have a square or rectangular shape as well. The circular shape is a preferred shape as this uses less material when making the heater rack.

It should also be understood that the attachment nodes that do not have any mechanical means or features that prevent the ceramic support from moving between the insertion and operational positions, including the ones that have a partial anti-rotation feature, can be employed in the same kinds of arrays and arrangements, including those with one or more plate members and folding capabilities, as described above for the embodiment of the invention that employs a tab for ceramic support retention, see FIGS. 8A to 33B.

As such, an invention has been disclosed in terms of preferred embodiments thereof which fulfills each and every one of the objects of the present invention as set forth above and provides a new and improved heater rack for use in heater assemblies that use ceramic supports and open type electrical resistance heating elements and a method of use.

Of course, various changes, modifications and alterations from the teachings of the present invention may be contemplated by those skilled in the art without departing from the intended spirit and scope thereof. It is intended that the present invention only be limited by the terms of the appended claims.

I claim:

1. A one-piece heater rack for supporting open coil electrical resistance heater elements using ceramic supports comprises a single sheet of material having a front side and a back side, the single sheet of material further comprising:
a peripheral structure, and
a plurality of an array of attachment nodes, each attachment node configured to secure at least one ceramic support to the attachment node, the attachment nodes extending between portions of the peripheral structure, each attachment node having a peripheral portion that forms:
a first opening configured to allow a ceramic support to be positioned in the first opening from either the front side or the back side,
a second opening configured to receive a central portion of the ceramic support by either sliding or twisting of the ceramic support,
wherein the peripheral portion completely surrounds both the first and second openings.

2. The one-piece heater rack of claim 1, further comprising at least one plate member, the at least one plate member being part of the peripheral structure, being positioned between adjacent attachment nodes or between adjacent attachment node arrays, the at least one plate member having one or more openings therein to either facilitate mounting of heater components to the at least one plate member, control air flow over or through the one-piece heater rack, and/or permit bending of parts of the at least one plate member.

3. The one-piece heater rack of claim 1, wherein attachment nodes in one or more of the plurality of arrays are either evenly or unevenly spaced along the array.

4. The one-piece heater rack of claim 1, wherein the attachment nodes include at least two different sizes to hold different sized ceramic supports.

5. The one-piece heater rack of claim 1, wherein each array of attachment nodes comprises connecting arms between adjacent attachment nodes.

6. The one-piece heater rack of claim 5, wherein a width of each connecting arm in the array of attachment nodes is less than a width of the attachment node or the same width as the attachment node.

7. The one-piece heater rack of claim 1, wherein adjacent second openings of attachment nodes in an array of attachment nodes or adjacent second openings in adjacent arrays of attachment nodes from a perspective of travel of an open type coil electrical resistance heater element between adjacent second openings are separated by an open space so that an open type coil electrical resistance element mounted on ceramic supports held in the adjacent second openings and that may sag over the open space do not contact a part of the one-piece heater rack and cause a short circuit.

8. The one-piece heater rack of claim 1, wherein each attachment node has at least two second openings to support a pair of ceramic supports.

9. The one-piece heater rack of claim 8, wherein each attachment node has at least two first openings and two second openings.

10. The one-piece heater rack of claim 1, wherein the second opening is in the form of a slot adjacent to the first opening, the slot adapted to slidably receive a central portion of the ceramic support for securement to the attachment node.

11. The one-piece heater rack of claim 1, wherein the second opening is in the form of a pair of cut-outs in opposing edges of the first opening, the pair of cut-outs receiving a central portion of the ceramic support upon twisting of the ceramic support.

12. The one-piece heater rack of claim 1, wherein the arrays of attachment nodes are parallel to each other.

13. The one-piece heater rack of claim 1, wherein the attachment nodes in one array are interconnected by first connecting arms and adjacent arrays of the attachment nodes are interconnected by second connecting arms.

14. The one-piece heater rack of claim 2, wherein the at least one plate member extends between two adjacent arrays of attachment nodes.

15. The one-piece heater rack of claim 2, wherein the at least one plate member is part of the peripheral structure, is located on an end portion of the one-piece heater rack, and is bendable such that the plate member would be perpendicular to a plane of the one-piece heater rack once bent.

16. The one-piece heater rack of claim 2, comprising two plate members, one plate member being part of the peripheral structure and located on an end portion of the one-piece heater rack and one plate member being part of the peripheral structure and located on a side portion of the one-piece heater rack.

17. The one-piece heater rack of claim 1, wherein the peripheral structure includes a channel to receive wiring of heater components for radiant heat protection of the wiring.

18. The one-piece heater rack of claim 1, wherein the attachment nodes in one or more of the plurality of arrays are angled with respect to an array direction so that a coil mounted to ceramic supports held in the second openings of the angled attachment nodes would follow a non-linear path.

19. The one-piece heater rack of claim 5, wherein a portion of the peripheral portion of the attachment nodes and the connecting arms positioned adjacent the attachment nodes having the portion of the peripheral portion form a part of the peripheral structure of the one-piece heater rack.

20. The one-piece heater rack of claim 14, wherein the plate member is foldable so that a portion of the plate member would be perpendicular to a plane of the one-piece heater rack when folded.

21. The one-piece heater rack of claim 1, further comprising two sets of the plurality of arrays of attachment nodes, the two sets of the plurality of arrays of attachment nodes separated by a plate section, the plate section bendable along two spaced apart lines extending along the plate section so that the two sets of plurality of arrays of attachment nodes would be parallel to each other after bending along the two spaced apart lines.

22. A heater assembly comprising:
one or more open coil resistance heater elements,
a plurality of ceramic supports configured on at least one end thereof to engage and support the one or more open type coil electrical resistance heater elements, and
a heater rack retaining the ceramic supports, the heater rack further comprising the one-piece heater rack of claim 1,
the one or more open coil resistance heater elements engaged to the ceramic supports holding the ceramic supports in place.

23. A method of heating a space using a heater assembly, comprising:
providing the heater assembly of claim 22 in the space; and
supplying power to the heater assembly to heat said space.

24. The one-piece heater rack of claim 1, wherein the first opening is a slot in the peripheral portion and a plurality of second openings are spaced along a length of the slot.

25. The one-piece heater rack of claim 1, further comprising at least one plate member as part of the peripheral structure, the plate member bendable with respect to the peripheral structure, and further wherein the peripheral structure having the arrays of attachment nodes is bendable with respect to the peripheral structure.

26. A one-piece heater rack for supporting open coil electrical resistance heater elements using ceramic supports comprises a single sheet of material having a front side and a back side, the single sheet of material further comprising:
a peripheral structure, and
a plurality of arrays of attachment nodes, each attachment node configured to secure at least one ceramic support to the attachment node, the attachment nodes extending between portions of the peripheral structure, each attachment node having a peripheral portion that forms:
a first opening configured to allow a ceramic support to be positioned in at least a portion of the first opening,
a second opening configured to receive a central portion of the ceramic support by twisting of the ceramic support,
wherein the first opening is a slot having side faces extending between a peripheral edge at an outermost portion of the peripheral portion and the second opening has at least one curved edge face terminating where the slot meets the second opening, or
wherein the first opening includes a slot having side faces extending between a peripheral edge face at an outermost portion of the peripheral portion and the second opening has a first slot portion intended to receive a portion of the ceramic support and a second slot portion angled with respect to the first slot portion and configured to receive a central portion of the ceramic support by twisting of the ceramic support.

27. The one-piece heater rack of claim 26, wherein the peripheral portion includes means to retain the ceramic support in either the second opening or second slot portion.

28. The one-piece heater rack of claim 26, wherein the retaining means is one of bendable tabs or a raised protrusion extending from a face of the peripheral portion.

29. The one-piece heater rack of claim 26, wherein the first opening is the slot having side faces extending between the peripheral edge at the outermost portion of the peripheral portion and the second opening has the curved edge face terminating where the slot meets the second opening.

30. The one-piece heater rack of claim 26, wherein the side faces of the slot are generally parallel to each other or diverge inwardly to the peripheral edge face of the peripheral portion.

31. The one-piece heater rack of claim 26, further comprising at least one plate member as part of the peripheral structure, the plate member bendable with respect to the peripheral structure, and further wherein the peripheral structure having the arrays of attachment nodes is bendable with respect to the peripheral structure.

32. The one-piece heater rack of claim 26, further comprising at least one plate member, the at least one plate member being part of the peripheral structure, being positioned between adjacent attachment nodes or between adjacent attachment node arrays, the at least one plate member having one or more openings therein to either facilitate mounting of heater components to the at least one plate member, control air flow over or through the one-piece heater rack, and/or permit bending of parts of the at least one plate member.

33. The one-piece heater rack of claim 26, wherein attachment nodes in one or more of the plurality of arrays are either evenly or unevenly spaced along the array.

34. The one-piece heater rack of claim 26, wherein the attachment nodes include at least two different sizes to hold different sized ceramic supports.

35. The one-piece heater rack of claim 26, wherein each array of attachment nodes comprises connecting arms between adjacent attachment nodes.

36. The one-piece heater rack of claim 35, wherein a width of each connecting arm in the array of attachment nodes is less than a width of the attachment node or the same width as the attachment node.

37. The one-piece heater rack of claim 26, wherein adjacent second openings of attachment nodes in an array of attachment nodes or adjacent second openings in adjacent arrays of attachment nodes from a perspective of travel of an open type coil electrical resistance heater element between adjacent second openings are separated by an open space so that an open type coil electrical resistance element mounted on ceramic supports held in the adjacent second openings and that may sag over the open space do not contact a part of the one-piece heater rack and cause a short circuit.

38. The one-piece heater rack of claim 26, wherein the arrays of attachment nodes are parallel to each other.

39. The one-piece heater rack of claim 26, wherein the attachment nodes in one array are interconnected by first connecting arms and adjacent arrays of the attachment nodes are interconnected by second connecting arms.

40. The one-piece heater rack of claim 32, wherein the at least one plate member extends between two adjacent arrays of attachment nodes.

41. The one-piece heater rack of claim 32, wherein the at least one plate member is part of the peripheral structure, is located on an end portion of the one-piece heater rack, and is bendable such that the plate member would be perpendicular to a plane of the one-piece heater rack once bent.

42. The one-piece heater rack of claim 32, comprising two plate members, one plate member being part of the peripheral structure and located on an end portion of the one-piece heater rack and one plate member being part of the peripheral structure and located on a side portion of the one-piece heater rack.

43. The one-piece heater rack of claim 26, wherein the peripheral structure includes a channel to receive wiring of heater components for radiant heat protection of the wiring.

44. The one-piece heater rack of claim 26, wherein the attachment nodes in one or more of the plurality of arrays are angled with respect to an array direction so that a coil mounted to ceramic supports held in the second openings of the angled attachment nodes would follow a non-linear path.

45. The one-piece heater rack of claim 35, wherein a portion of the peripheral portion of the attachment nodes and the connecting arms positioned adjacent the attachment nodes having the portion of the peripheral portion form a part of the peripheral structure of the one-piece heater rack.

46. The one-piece heater rack of claim 32, wherein the plate member is foldable so that a portion of the plate member would be perpendicular to a plane of the one-piece heater rack when folded.

47. The one-piece heater rack of claim 26, further comprising two sets of the plurality of arrays of attachment nodes, the two sets of the plurality of arrays of attachment nodes separated by a plate section, the plate section bendable along two spaced apart lines extending along the plate section so that the two sets of plurality of arrays of attachment nodes would be parallel to each other after bending along the two spaced apart lines.

48. A heater assembly comprising:
one or more open coil resistance heater elements,
a plurality of ceramic supports configured on at least one end thereof to engage and support the one or more open type coil electrical resistance heater elements, and
a heater rack retaining the ceramic supports, the heater rack further comprising the one-piece heater rack of claim 26,
the one or more open coil resistance heater elements engaged to the ceramic supports holding the ceramic supports in place.

49. A method of heating a space using a heater assembly, comprising:
providing the heater assembly of claim 48 in the space; and
supplying power to the heater assembly to heat said space.

50. The one-piece heater rack of claim 1, wherein the second opening includes at least one curved edge face for engaging a central portion of the ceramic support.

51. The one-piece heater rack of claim 1, wherein the second opening includes a pair of opposing curved edge faces for engaging a central portion of the ceramic support.
